(19) United States
(12) Patent Application Publication
(10) Pub. No.: US 2021/0097630 A1
(43) Pub. Date: Apr. 1, 2021

(54) Web-Based Platform and Method for Providing Interactive Interface Between Performing Artists and Others

(71) Applicant: Capsul Tools, LLC, Atlanta, GA (US)

(72) Inventor: Omar E. Whilby, Atlanta, GA (US)

(73) Assignee: Capsul Tools, LLC, Atlanta, GA (US)

(21) Appl. No.: 17/037,587

(22) Filed: Sep. 29, 2020

Related U.S. Application Data
(60) Provisional application No. 62/908,099, filed on Sep. 30, 2019.

(51) Int. Cl. G06Q 50/00; G06Q 30/02; H04L 29/06; G06F 16/64; G06N 5/02

(52) U.S. Cl. CPC G06Q 50/01; G06Q 30/0204; G06Q 30/0252; G06Q 2230/00; H04L 63/10; G06F 16/64; G06N 5/022; G06Q 30/0282

(57) ABSTRACT

A system and method for grouping individuals by providing a music platform and updating the events. The group of individuals includes a business owner, a promoter, a DJ, an artist, a host, and a general user. The system and method include the steps of acquiring music event data from a plurality of data sources, acquiring artist data and providing an application that allows an authorized user of the application to access information associated with the music event, including details about the event location, date and time, the performing artists, and the promoters for the event. The business owners can save their favorite artists, flag upcoming events, access special promotions and create and manage the database, wherein the database includes information related to promoters, events, and artists.

### CROSS-REFERENCE TO RELATED APPLICATIONS

This application claims the benefit of the filing date of and priority to: U.S. Provisional Application Ser. No. 62/908,099 entitled “Web-Based Platform and Method for Providing Interactive Interface Between Performing Artists and Others” and filed Sep. 30, 2019, Confirmation No. 2139; said provisional application is incorporated by reference herein in its entirety for all purposes.

### STATEMENT REGARDING FEDERALLY SPONSORED RESEARCH OR DEVELOPMENT

Not Applicable.

### COPYRIGHT AUTHORIZATION

©2019 Capsul Tools, LLC. A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND OF THE INVENTION

### Field of the Invention

The present disclosure generally relates to a web-based platform and method for providing interactive interface between performing artists and others. The present disclosure also generally relates to a web application ability to centralize the way a performing artist's events are coordinated, managed and promoted. The present disclosure also generally relates to a web-based app platform to coordinate the activities of a performing artist with a host of interested parties, including the artist, businesses (including performance venues, business managers), promotors, disc jockeys (“DJs”) present at a performance event of the artist, event hosts, and general users such as the artist's fans or the audience at a performance event featuring the artist. The present disclosure also pertains to a built-in mechanism to market to an audience of the artist.

The present invention also generally relates to optimizing communication about entertainment. It finds application in conjunction with, e.g., live music, and will be described with particular reference thereto. Many entertainment communication channels are fragmented or narrowly focused and lack the ability to present a user or other interested parties with a comprehensive view of entertainment events and information.

The present disclosure provides interactive multimedia action and activity feeds to users for fast viewing and accessing of a plurality of connected or related user's specific plurality of events details or actions and activities items in a user-friendly manner.

In particular, the present disclosure is directed to a mobile and web-based interactive software application or app referred to herein as the “Sound Capsul” app or “the app” or “the application” that can be used on, e.g., a smart phone device to display screen content when the system or app is used according to embodiments of the present disclosure.

Various prior art devices have been designed for maintaining event information. However, these prior art devices lack in, e.g., centralizing the artist events.

For example, U.S. Patent Publication No. 20120277994 (Broome), entitled “System and method to providing event-based services” describes event-based services where merchants and users subscribe with an Event Service Provider (ESP), which includes a server and database. The database maintains information relating to merchant events and subscriber's event preferences. Based on time-sensitive merchant event information, an event is published. Furthermore, the database is queried to determine the preferred subscribers based upon the subscriber's event preferences and the merchant event information relating to the published event. Lastly, an event communication is delivered to the device associated with the preferred subscriber.

U.S. Patent Publication No. 20110282700 (Cockcroft) entitled: “Web application for a mobile computing device to provide location-based upcoming event information” describes systems and methods related to providing location-based upcoming event information. The location-based upcoming event information may be provided to users of an online secondary ticket marketplace using the web application installed on a mobile computing device of the user. The web application may be configured to communicate with a network-based system that provides online marketplace and ticket fulfillment services and to provide the user with upcoming event information based on the location of the user and other event criteria, such as artists and/or genres of interest to the user.

U.S. Patent Publication No. 20170336934 (Brillon et al.) entitled: “Jukebox with customizable avatar” describes a digital downloading jukebox system including a mechanism for delivering custom services to a recognized user is provided. For example, information specific to a recognized user may be stored and optionally may include a recognized user avatar representative of the recognized user. The user avatar may be an image, video, and/or animation, which may be displayed on and/or played through the jukebox. The user avatar may be associated with transactions associated with the user. For example, an avatar may be displayed when a playlist of the recognized user is played, when a message is sent, etc. In other examples, the avatar may introduce instances of media by playing an audio and/or video message, and the avatar may sing, dance, etc. while an instance of media is playing.

U.S. Patent Publication No. 20090138111 (Mastronardi) entitled: “Process for selecting a recording on a digital audiovisual reproduction system, and system for implementing the process” discloses a process of selecting a recording on an audiovisual reproduction system consists of displaying a number of windows on a touch screen as an interface with a user. Items of information are stored in a bulk memory and are representative of an image of the album cover that is associated with each window and whose corresponding musical recording is stored in the bulk memory of the reproduction system. Each zone of a window is associated, via the touch-screen interface software, with at least one address for accessing the items of information in the database that is stored in the bulk memory belonging to the album cover whose image is displayed in the window that is touched by the user.

U.S. Patent Publication No. 20180922195 (Lee et al.) entitled: “Method for recommending music in a playlist and apparatus using the same” discloses a method for recommending music in a playlist. The method includes: receiving at least one selection track; determining at least one recommended track for the received selection track by using an engine, the engine configured to predict a track to be played next among potential tracks based on an order of tracks in a playlist; and providing the at least one determined recommended track.

These prior art references do not contain a central functionality providing an ability to centralize the way artist events are coordinated, managed and promoted or other features set out below. Therefore, there remains a need to provide a system for grouping individuals for providing a music platform and an ability to centralize the way artist events, are coordinated, managed and promoted.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Various embodiments are directed to systems and methods related to a web- and mobile-based application for a mobile computing device that provides a platform to coordinate with Business, Artist, DJ's, and Hosts along with a built-in mechanism to market using the web application installed on a mobile computing device of the user.

The present disclosure provides a community network of persons interested in an artist, as well as the artist, through a web-based service. The system provides a coordination matrix to set out tiers of permissions and attributes associated with each user type. For example, a business entity (such as the artist's management, or an event venue's management) is provided by the app with a view of the total operation and the interactivity of others involved in an artist event. The system and app also provide an artist's promoter with a platform to coordinate with the business entity, artist, DJ, and/or event host along with a built-in mechanism to market to an audience. The system is designed to support a host of user classes with specific permissions assigned to each class of user; for example, the performing artist, the business entities involved with the performing artist and venues for performance, DJs that may be employed at such performance venues, the host or “MC” of the event, and the general users, such as fans of the artist or audiences present at a performance venue featuring the artist.

For example, on the day of an event, the system gives the promoter the ability to assign the order in which the artist performs adding additional song slots to an artist performance and to send push notifications to any and all team members assigned to the event or otherwise to monitor or interface with the event via the app. The present disclosure provides a top down interface supporting multiple levels of users all provided with specific functionality within the app. Enterprise management services are preferably provided for all of the user classifications with exception of the “General User” (i.e., fans, venue audience members, and others with just a general interest).

The present disclosure relates to an implemented system and method with a web application that has the ability to centralize the way artist events are coordinated, managed and promoted.

The present disclosure provides a top down interface supporting multiple levels of users all provided with specific functionality within the app.

The Business Owner user is provided a view of the total operation along with the ability to create/manage business, create/manage events, save the business owner's favorite Promoter, DJ, Artist, and Host. In accordance with an aspect of the present disclosure, the business owner has full access to all the functional areas of the app. The business owner is the administrator who has the highest access of all the users and can use all enabled application features. The business owner creates a business account, once the business account is created, promoters must get approval to create a business at that establishment. Business owners are able to create events without associated artist.

In accordance with an aspect of the present disclosure, the event promoter must create an account and register the promoter account. The promoter has the ability to create events with associated artists, add artists to events, add DJs and hosts to events, manage event songs order, enable/disable voting, enable/disable event registration, to view the promoter's events inside the app, download and play event music, to manage the promoter's personal profile, to send push notification to event artists, DJs, and hosts. During an event, a promoter can manually check in an artist making that artist song available for voting, listening, and downloading. The Promoter is provided a platform to coordinate with Business Owner, Artist, DJ's, and Host along with a built-in mechanism to market to an audience. On the day of the event, the app provides the promoter with the ability to assign the order in which an artist performs by adding additional song slots to an artist performance and sending push notifications to any and all team members assigned to the event.

In accordance with an aspect of the present disclosure, the DJ must create an account in the app and register the DJ's account. The DJ has the ability to view events, activate and deactivate voting, rearrange song order, turn on or off voting registration, download and play event songs, create/manage DJ profile, and manage events scoreboard.

In accordance with an aspect of the present disclosure, the artist must create an account and then the artist is able to register the artist's account. The artist can add up to ten pictures to the artist's profile in addition to the profile picture. The artist has the ability to add unlimited songs to the artist's profile, upload songs, upload images, edit artist information, sign up for an event, check into an event, and receive push notifications.

In accordance with an aspect of the present disclosure, during an event, the artist can open registration and submit the artist's performance song list for that event. Once the artist arrives at the event, the artist must physically check into the app. The artist will use the artist's phone GPS location to verify that the artist is at the specified event. Once the artist has checked in, the artist's song(s) becomes available for voting, listening, and downloading for that event.

In accordance with an aspect of the present disclosure, the host must create an account and then the host is able to register the host's account. The host has the ability to view events and create/manage the host's profile.

In accordance with an aspect of the present disclosure, a general user can register and then search for events and artists. The user can select the favorite artist, businesses, promoters, DJs, or host. The general user can also vote to rate events, promoters, artists, and artists songs.

Other or alternative features will become apparent from the following description, from the drawings, and from the claims.

### BRIEF SUMMARY OF THE DRAWINGS

Certain embodiments will hereafter be described with reference to the accompanying drawings, wherein like reference numerals denote like elements. It should be understood, however, that the accompanying drawings illustrate only the various implementations described herein and are not meant to limit the scope of various technologies described herein. The drawings are as follows:

FIGS. 1-36 depict exemplary screen shots from, e.g., a smart phone device, displaying screen content from a mobile and web-based interactive software application or app referred to herein as the “Sound Capsul” app or “the app” or “the application” when the system is used according to embodiments of the present disclosure. These screen shots are more particularly summarized below.

FIG. 1 depicts a sign-in screen for a registered user to login into the application using the user's login credentials (e.g., username and password). If the user has not yet registered, the user will be directed to a registration screen

FIG. 2 depicts a registration screen where a new user can register into the application.

FIG. 3 depicts a password recovery screen where the user can recover the user's password if forgotten/lost.

FIG. 4 depicts the application home screen where user is provided with several options to perform several functions.

FIG. 5 depicts a side menu drop down list accessed from the side menu button on the home screen and providing further functions. Also displayed is the user's primary profile.

FIG. 6 depicts an artist profile creation page, accessed from the home page side menu drop down list, where an artist can provide complete details about the artist.

FIG. 7 depicts an artist bio page.

FIG. 8 depicts an artist gallery page.

FIG. 9 depicts an artist music catalog page.

FIG. 10 again depicts a side menu drop down list accessed from the side menu button on the home screen and providing further functions, and also now displays an artist's profile.

FIG. 11 depicts a profile edit screen where user can edit the user's profile.

FIG. 12 depicts an edit page where an artist profile can be edited.

FIG. 13 depicts an artist gallery page where user can perform several functions through the provided fields, including scrolling through info about an artist.

FIG. 14 depicts a music page where an artist's songs can be uploaded.

FIG. 15 depicts an artist list page where user can find a listing of accessible artist information.

FIG. 16 depicts an exemplary artist page showing, e.g., the selected artist's bio.

FIG. 17 depicts an exemplary artist gallery page.

FIG. 18 depicts an artist music library page where artist can add the music and users can listen the music displayed in the listing of music.

FIG. 19 depicts a favorite event list page which can be accessed by the user.

FIG. 20 is a Sound Capsul favorite event page where the page displays a plurality of events and information related to these events.

FIG. 21 depicts a favorite event promoter information page displaying information about the promotor of the event.

FIG. 22 depicts a favorite event artist list where the page displays the list of artists associated with the particular event.

FIG. 23 is a favorite event Bout standings list where the user can view the “Bout” ratings associated with, e.g., the artists associates with that particular event.

FIG. 24 depicts a favorite artist list page where a user can select from the artists that the user has designated as the user's favorite artists.

FIG. 25 depicts a favorite artist Biographical page where user can see the biographical information of the selected favorite artist.

FIG. 26 depicts a favorite artist Sound Capsul gallery page.

FIG. 27 depicts a favorite artist track library page.

FIG. 28 depicts an event filter by date screen where user can view all events currently in the Sound Capsul network.

FIG. 29 depicts an event sort by date and distance screen where user can sort events based on their date or proximity to the user's location.

FIG. 30 depicts an event page where user can view listings of events, and e.g., designate them as favored or un-favored events.

FIG. 31 depicts an event promoter page where the user can view information about the promoter or organizer for the selected event.

FIG. 32 depicts an event artist list where, e.g., as list of artists associated with the event may be viewed along with music scheduled to be performed.

FIG. 33 depicts an Event Bout Rating where user can review a list of artists associated with the event along with the user's Bout ratings for their entry.

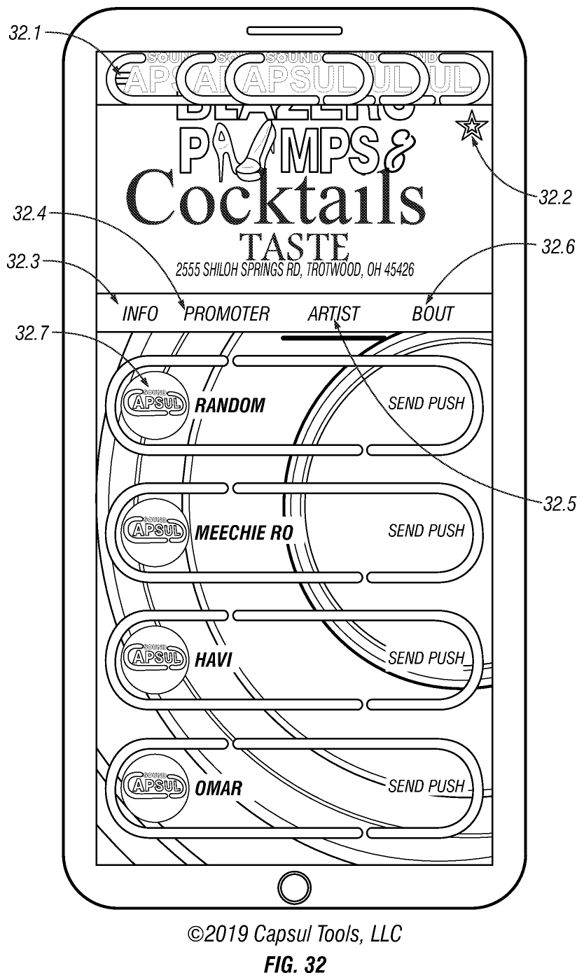

FIG. 32 depicts an artist page, shown here on the Bio tab.

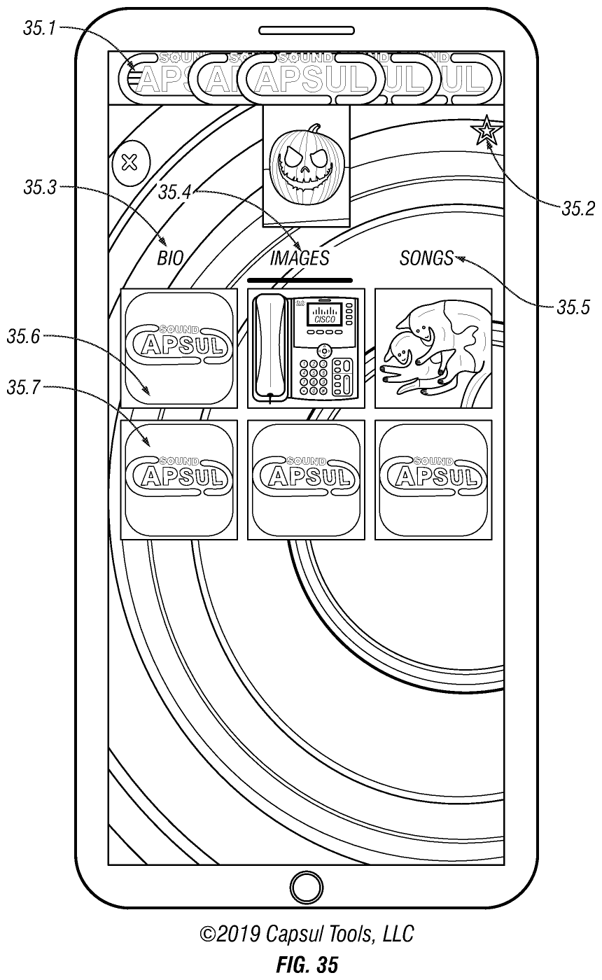

FIG. 35 depicts an artist image gallery page, shown here on the images tab.

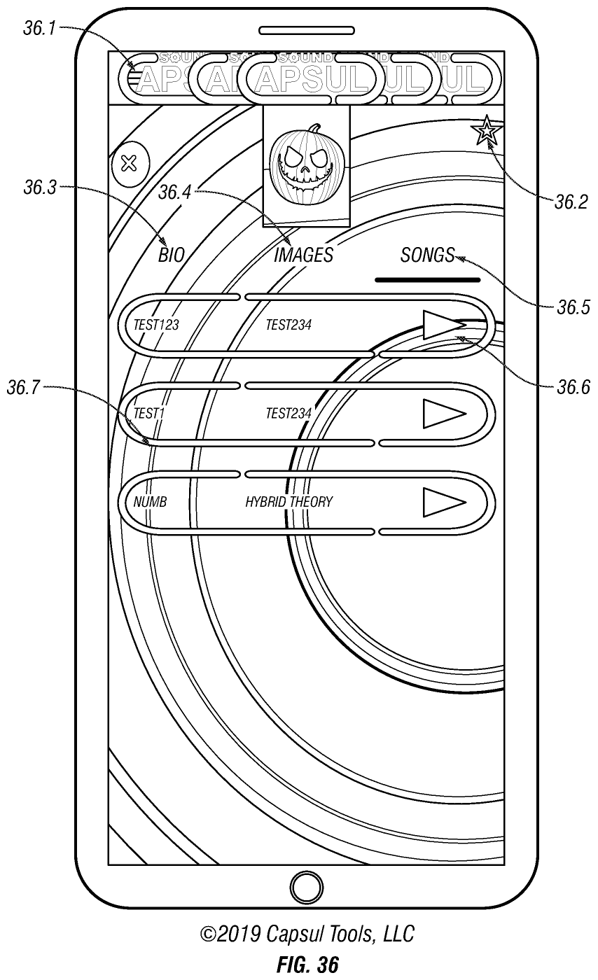

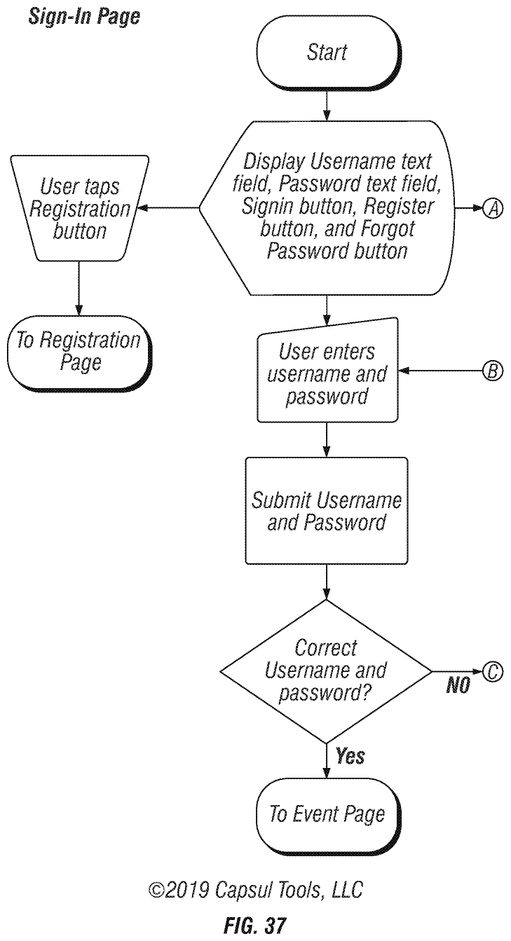

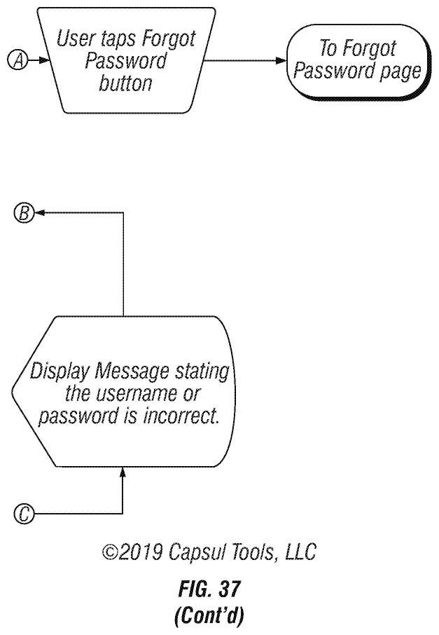

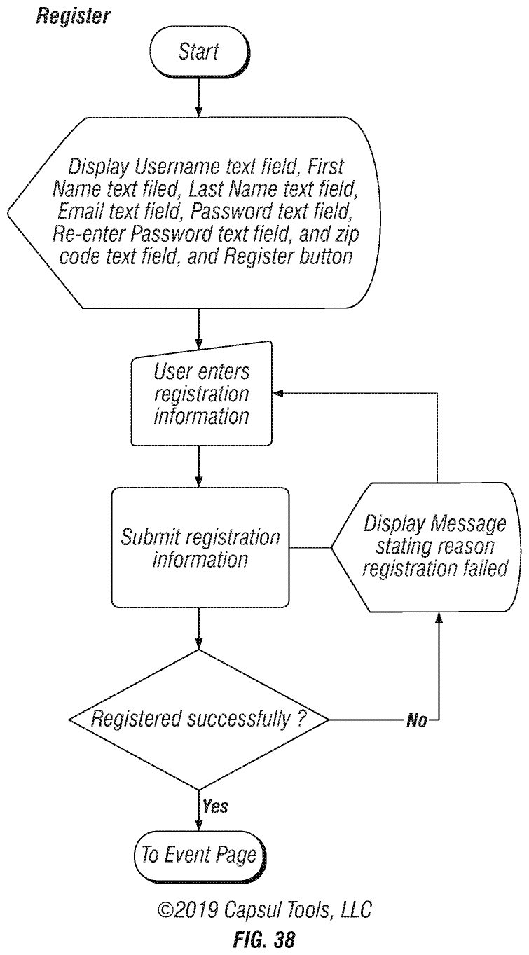

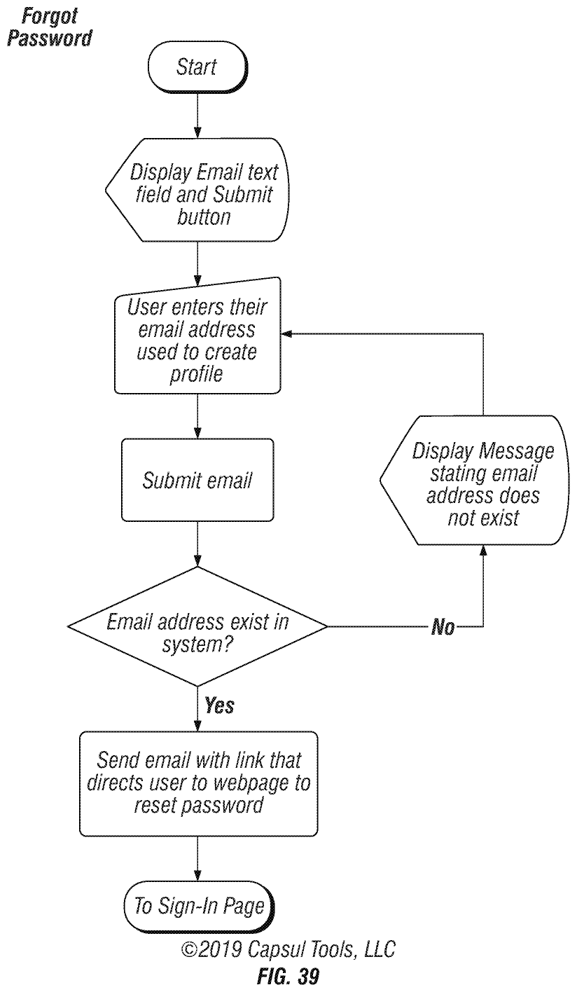

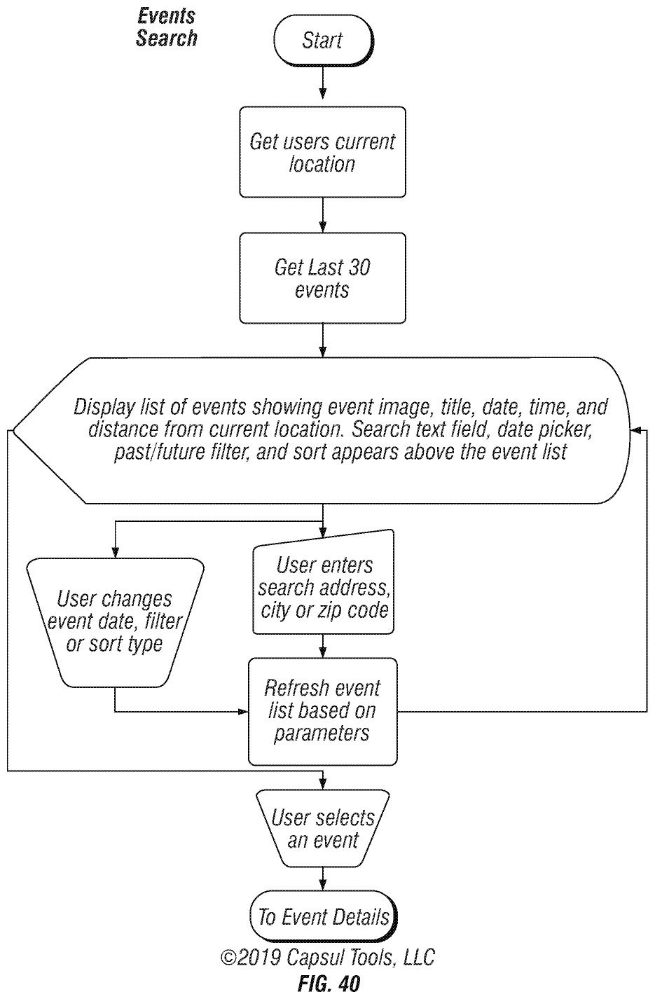

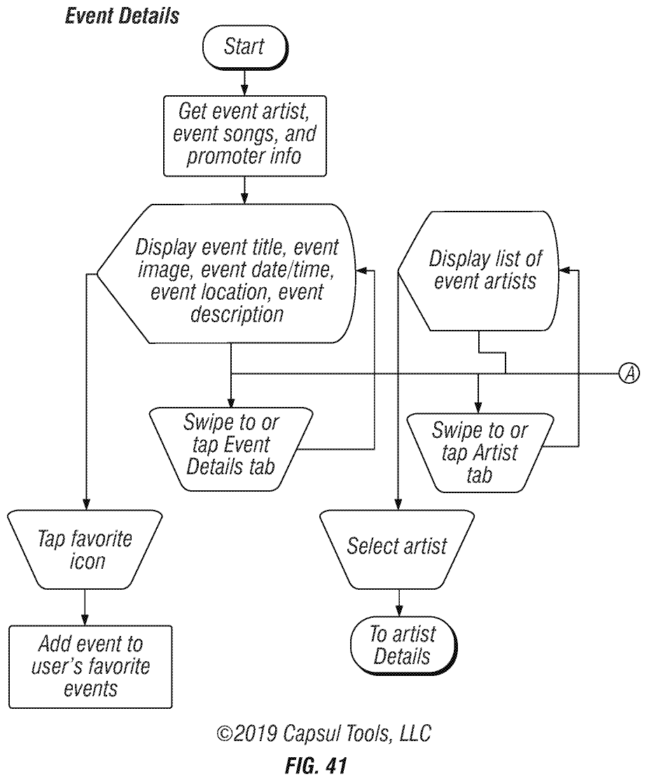

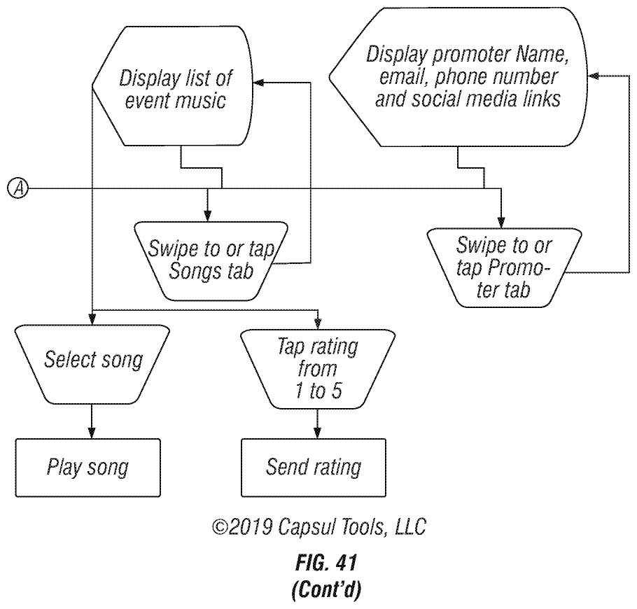

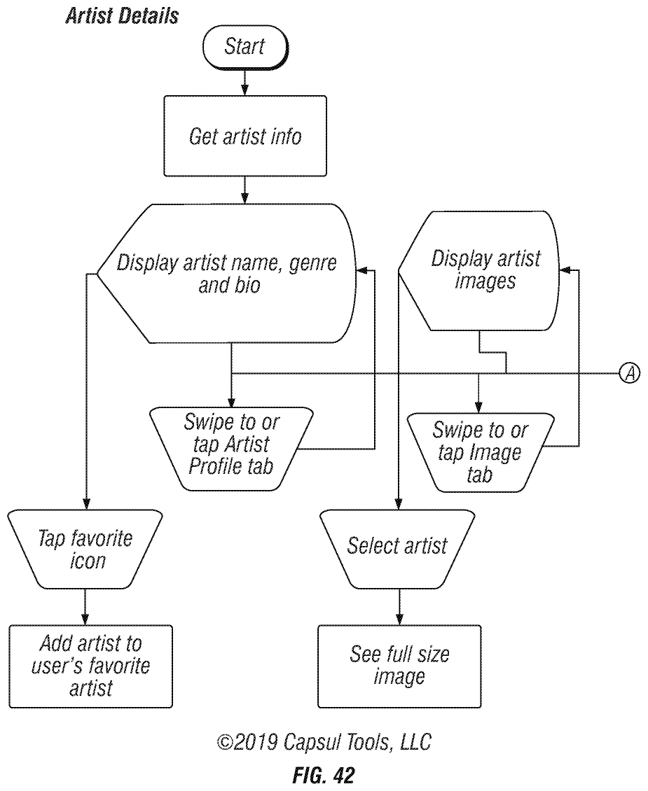

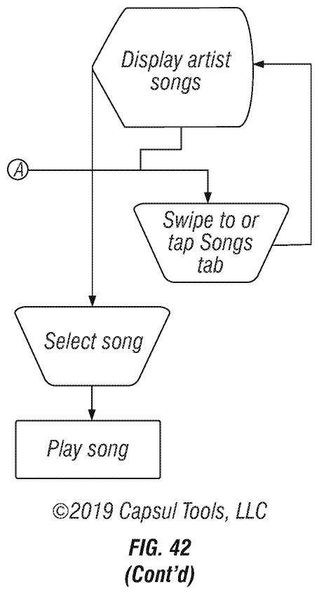

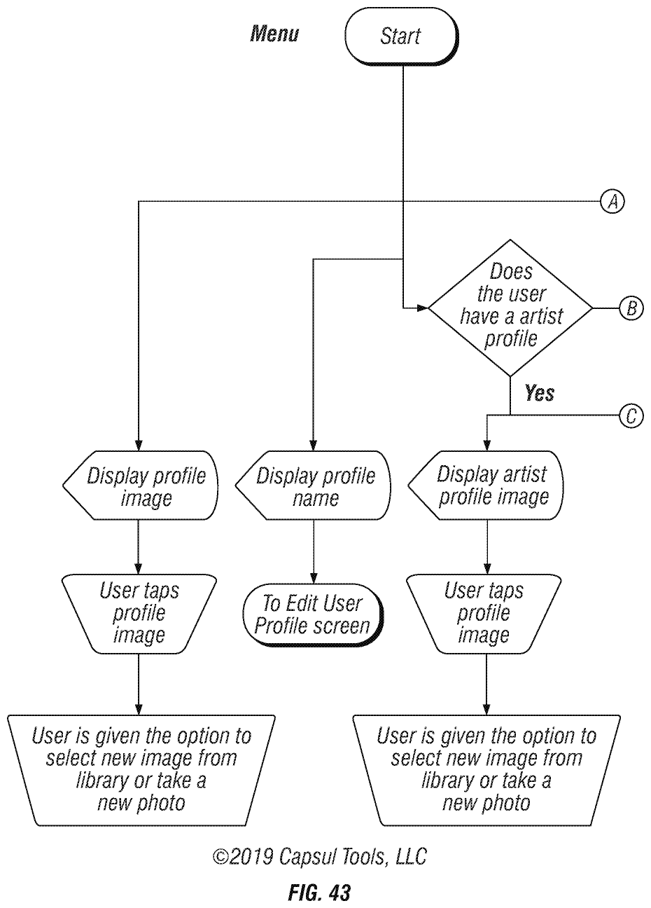

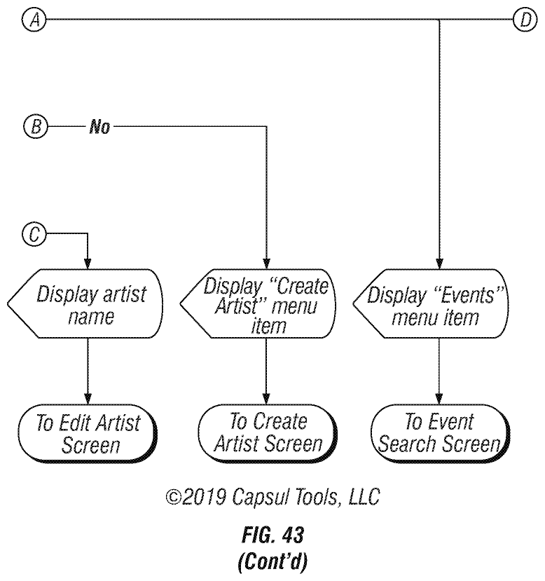

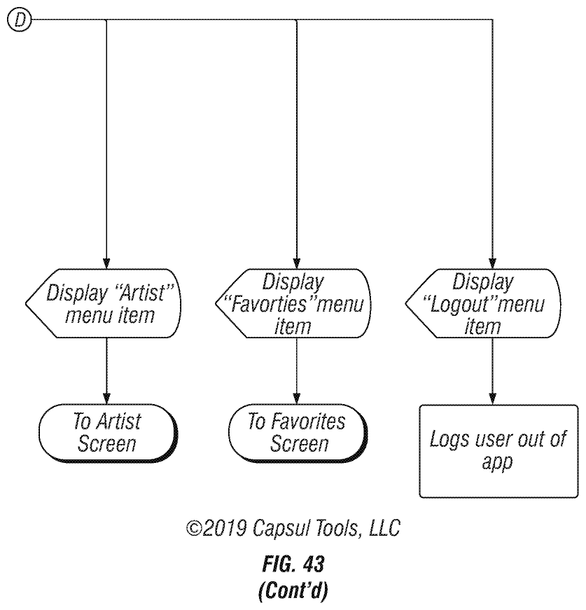

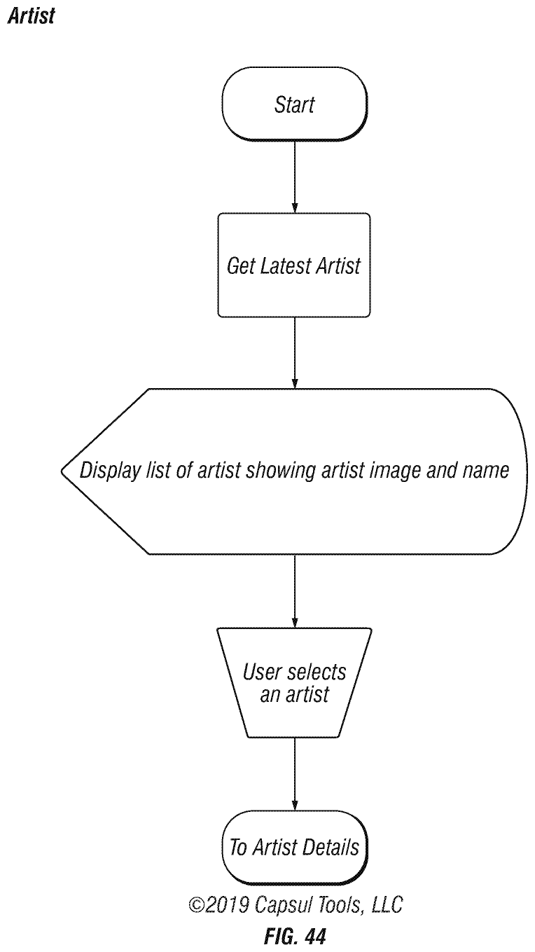

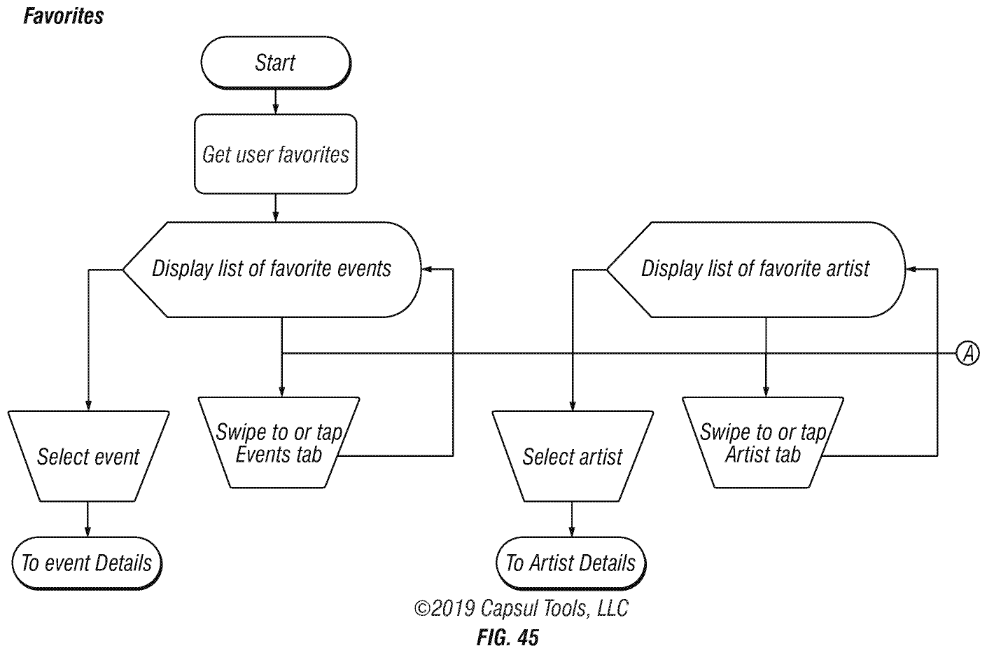

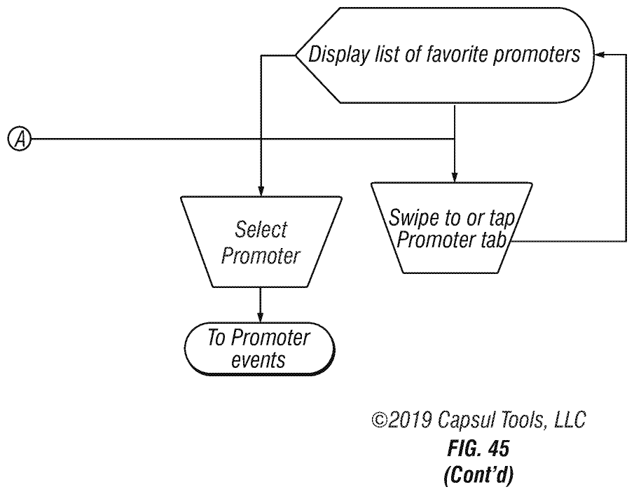

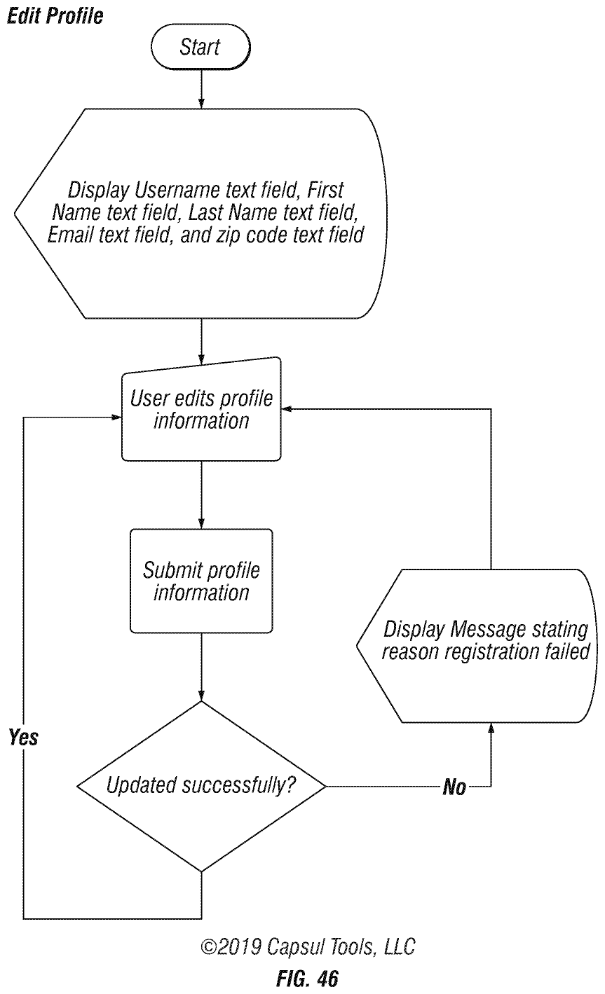

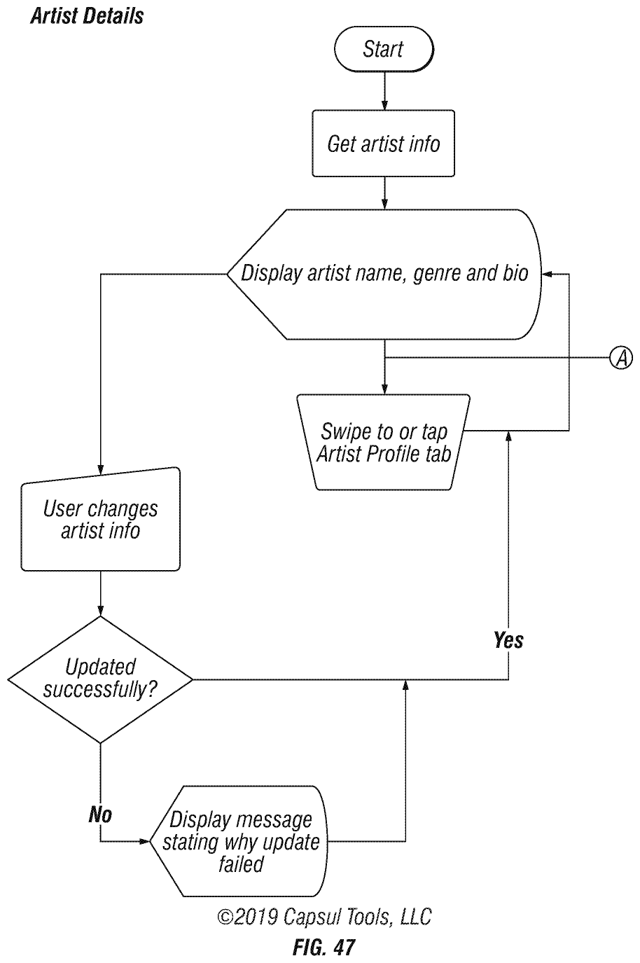

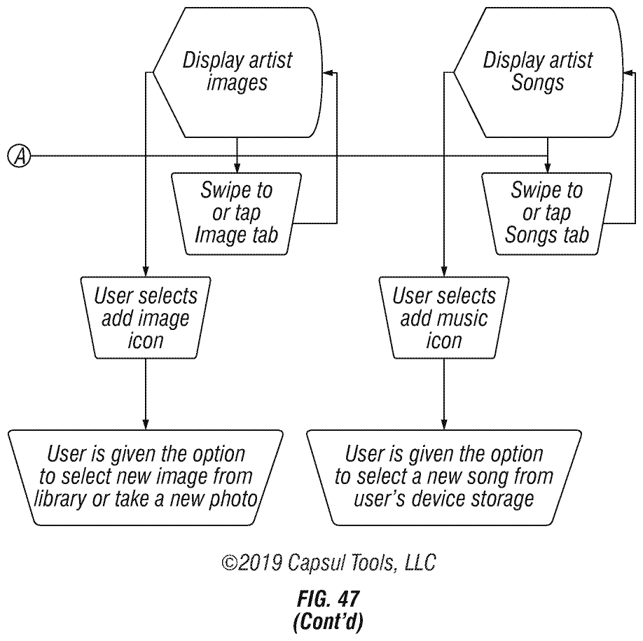

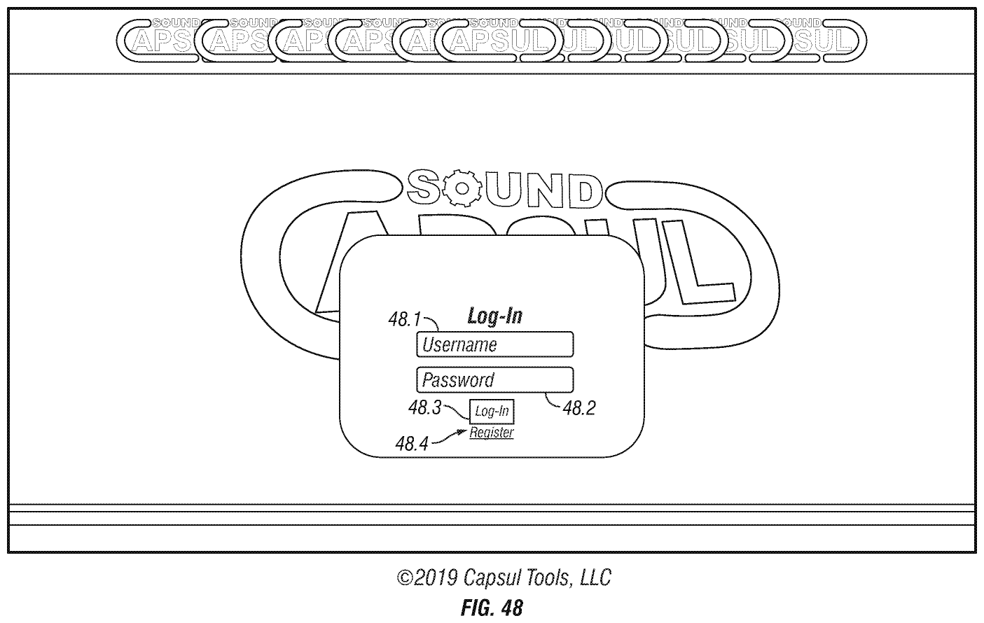

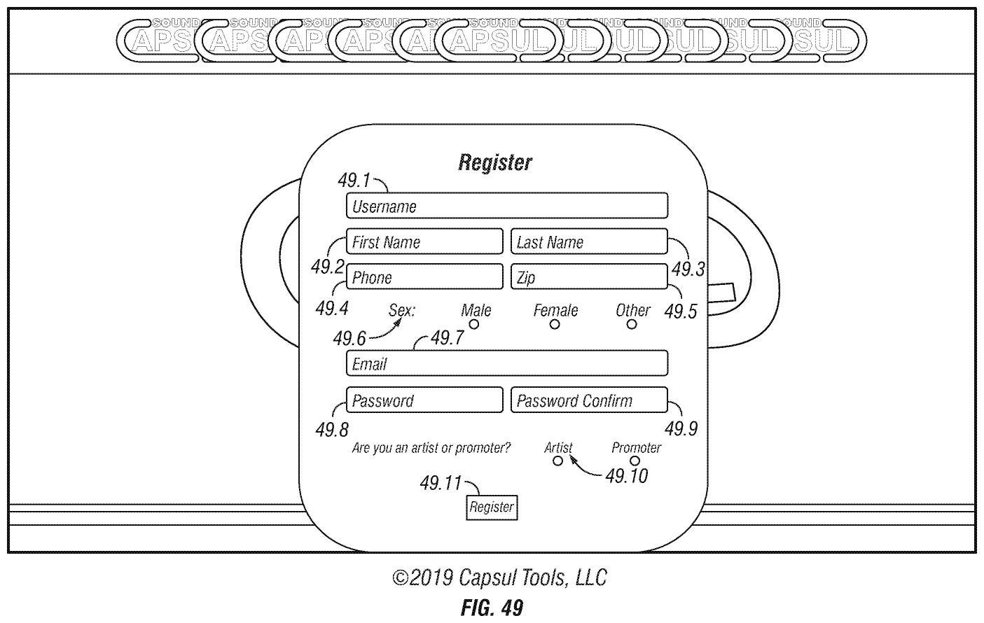

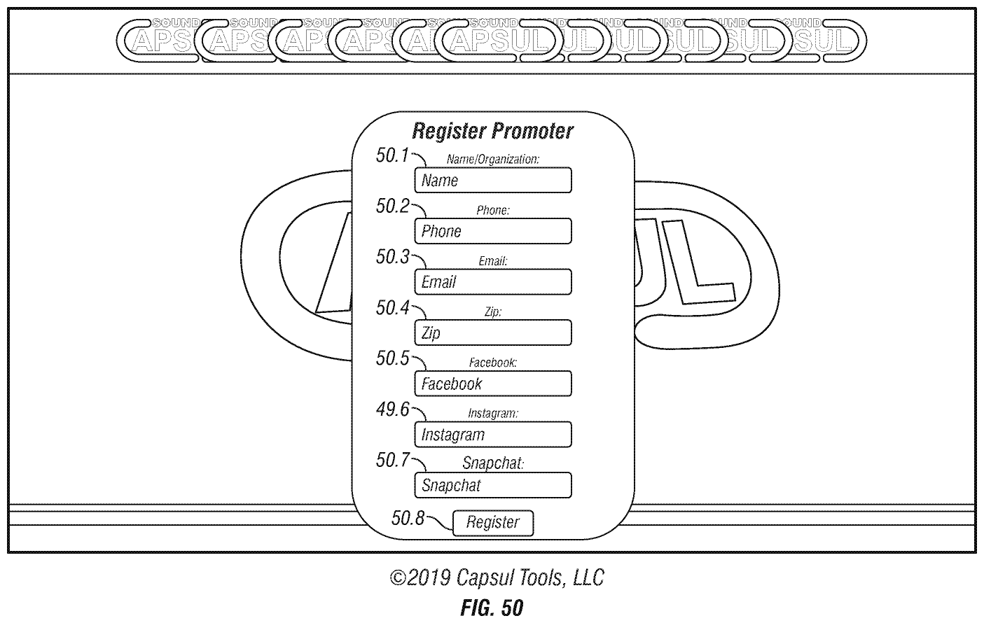

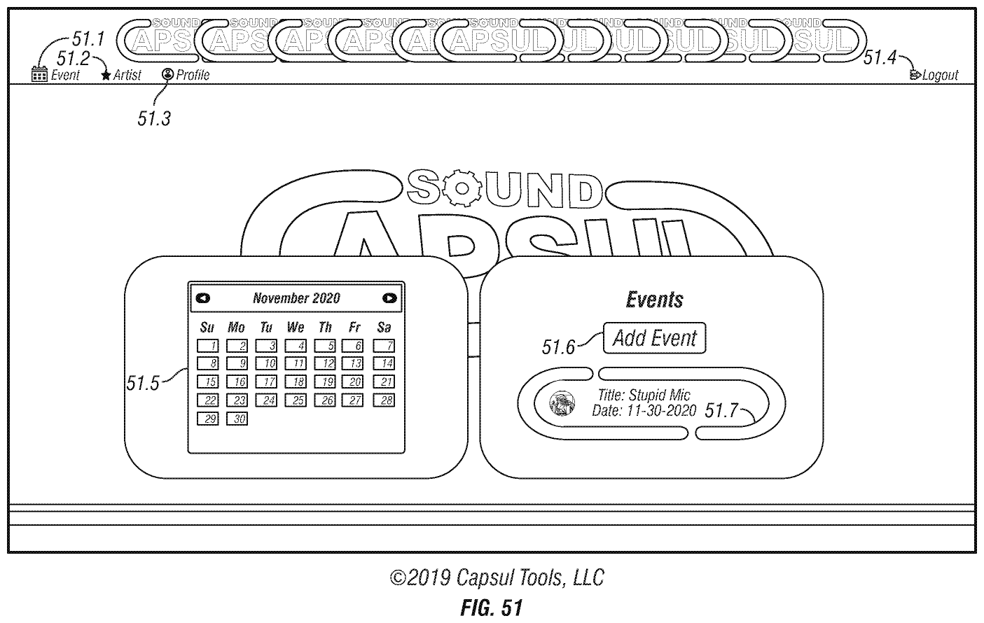

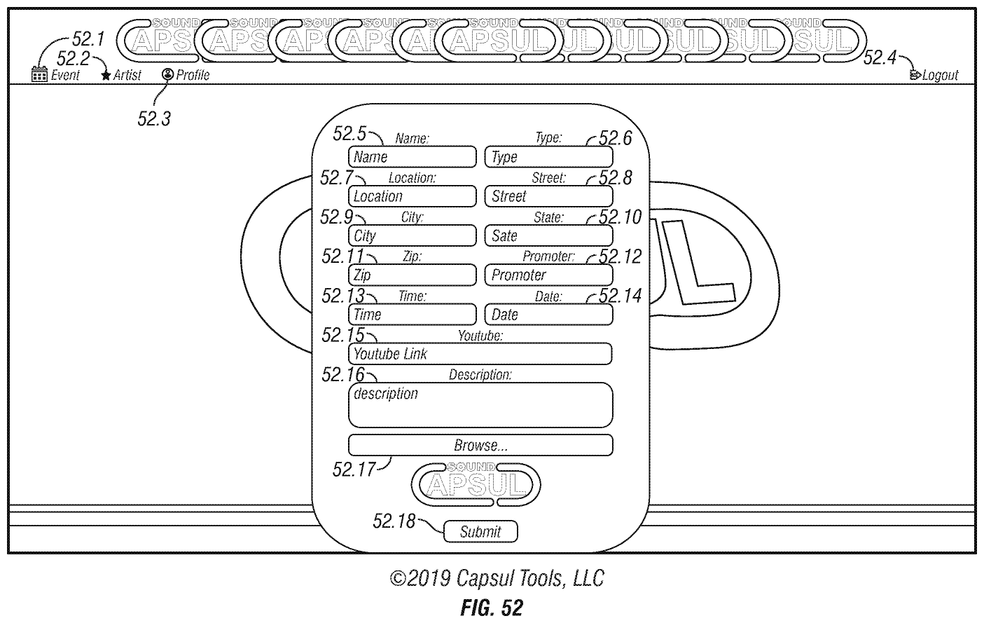

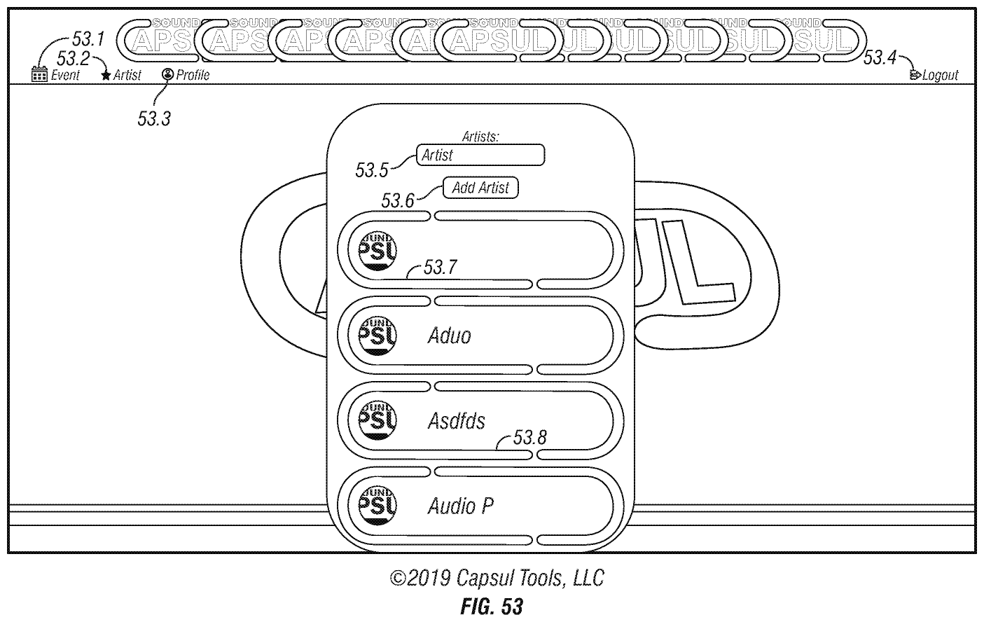

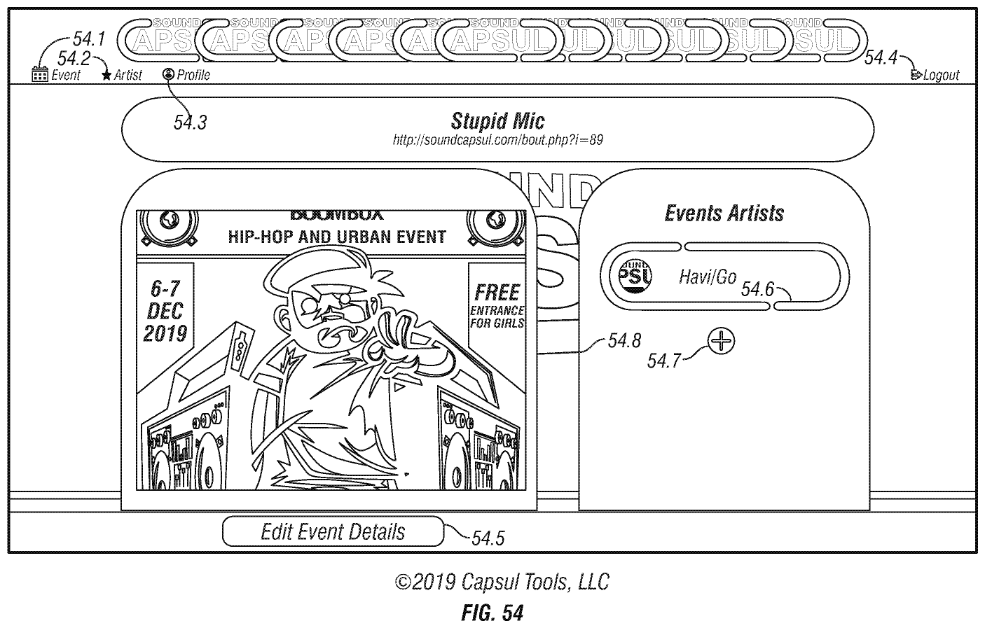

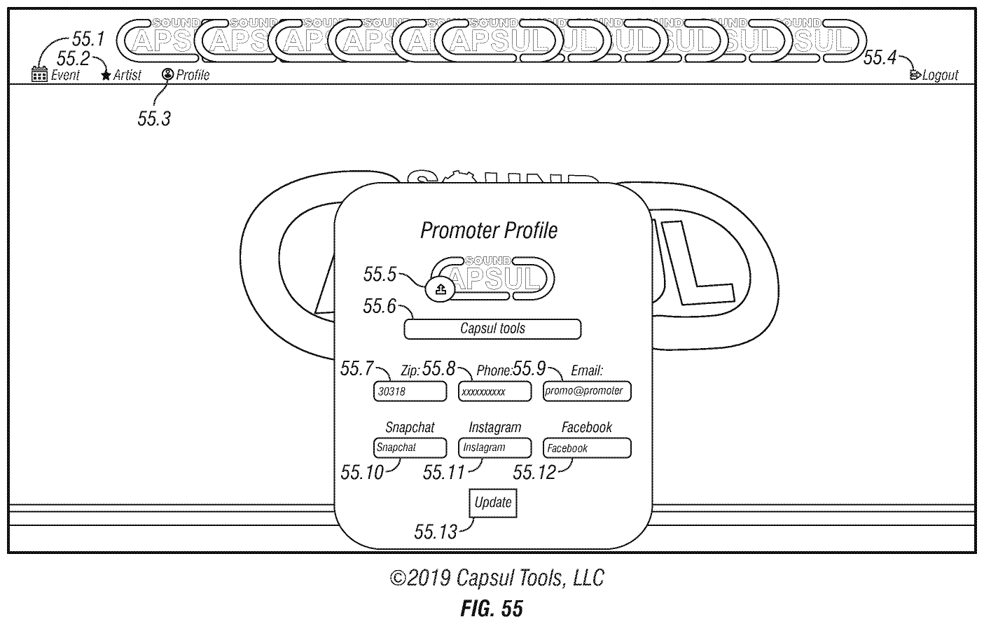

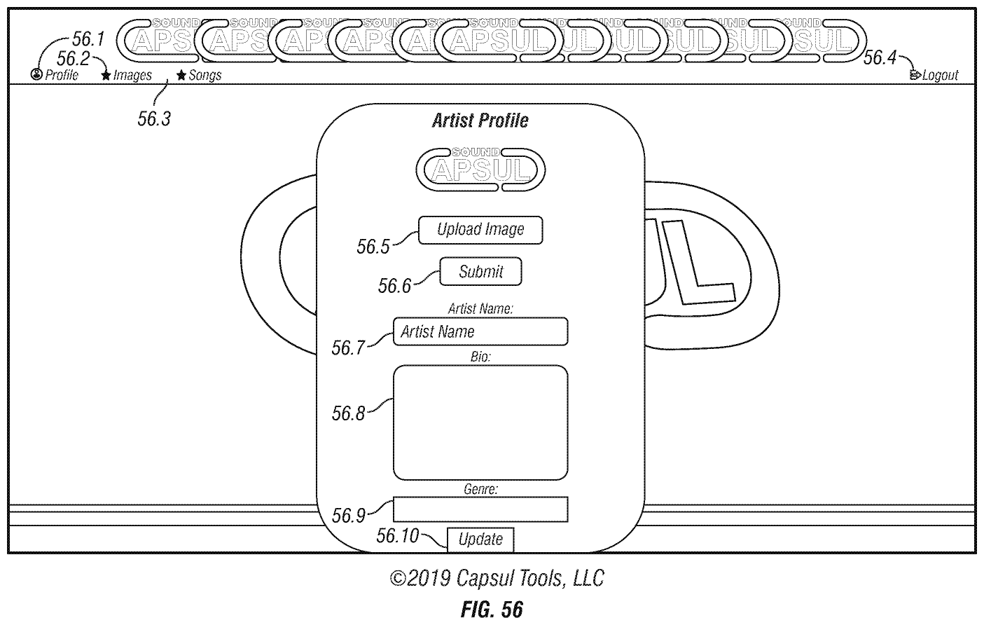

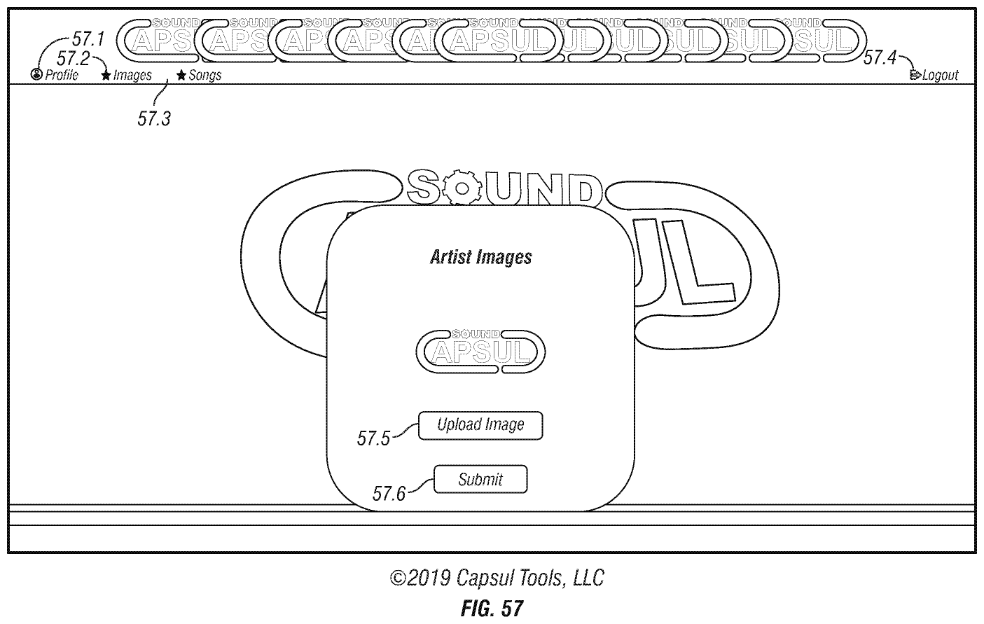

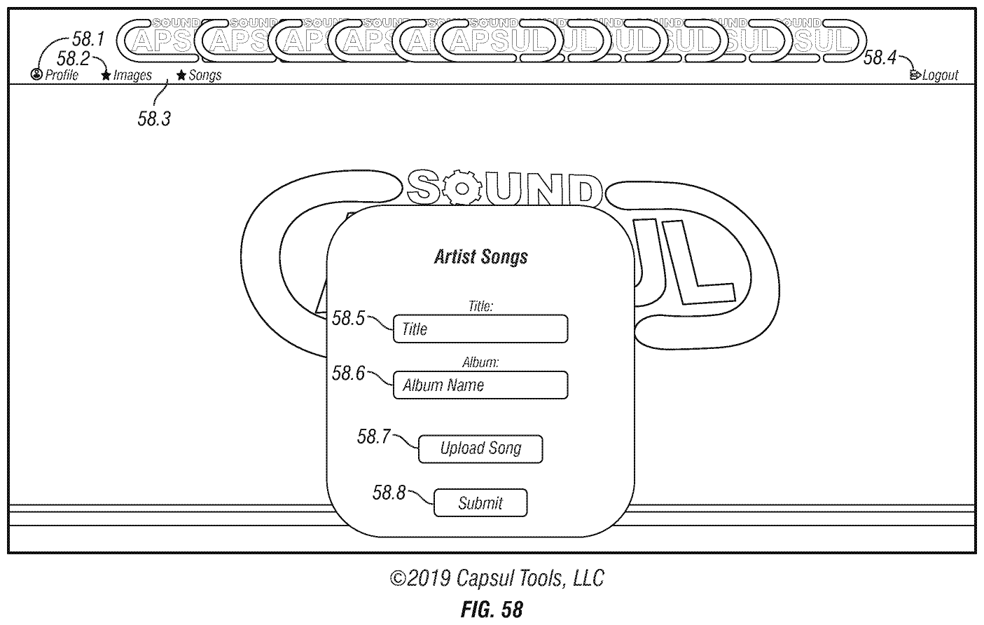

FIG. 36 depicts an artist library page where the user can listen to the selected track(s) by the artist, shown here on the songs tab.

FIGS. 37-47 represent exemplary flow charts depicting use of the Sound Capsul app as more fully summarized below.

FIG. 37 is a flowchart depicting a sign in process involved after installing the Sound Capsul application in the user communication device.

FIG. 38 is a flowchart depicting the registration process involved for accessing the Sound Capsul application after installation.

FIG. 39 is a flowchart depicting forgot password process, if user after registering the account forgets the password while signing into the application.

FIG. 40 is a flowchart depicting the event search page where user can search the events associate in the application.

FIG. 41 is a flowchart depicting the event details associated with an event.

FIG. 42 is a flowchart depicting the artist details associated in the Sound Capsul application.

FIG. 43 is a flowchart depicting the menu where user can create the artist profile.

FIG. 44 is a flowchart depicting the artist screen where user can get the artist details.

FIG. 45 is a flowchart depicting the favorite artist, promoter and event information to the user.

FIG. 46 is a flowchart depicting the edit profile screen where user can edit his/her profile.

FIG. 47 is a flowchart depicting the artist details where user can see the artist information.

FIGS. 48-58 depict exemplary screen shots displaying screen content from a web-based portal providing a user with access to the app when the system is used according to embodiments of the present disclosure. These screen shots are more particularly summarized below.

FIG. 48 is an exemplary screen shot from a web portal landing page for the login into the application using the user's login credentials (e.g., username and password). If the user has not yet registered, the user will be directed to a registration screen.

FIG. 49 is an exemplary screen shot from a web portal registration screen for the application.

FIG. 50 is an exemplary screen shot from a web portal promoter registration screen for the application.

FIG. 51 is an exemplary screen shot from a web portal event home screen for the application.

FIG. 52 is an exemplary screen shot from a web portal promoter event add screen for the application.

FIG. 53 is an exemplary screen shot from a web portal artist list screen for the application.

FIG. 54 is an exemplary screen shot from a web portal promoter event edit add artist screen for the application.

FIG. 55 is an exemplary screen shot from a web portal promoter profile edit screen for the application.

FIG. 56 is an exemplary screen shot from a web portal artist profile screen for the application.

FIG. 57 is an exemplary screen shot from a web portal artist image gallery screen for the application.

FIG. 58 is an exemplary screen shot from a web portal artist music add screen for the application.

### DETAILED DESCRIPTION

Reference throughout the specification to “one embodiment,” “an embodiment,” “some embodiments,” “one aspect,” “an aspect,” or “some aspects” means that a particular feature, structure, method, or characteristic described in connection with the embodiment or aspect is included in at least one embodiment of the present disclosure. Thus, the appearance of the phrases “in one embodiment” or “in an embodiment” or “in some embodiments” in various places throughout the specification are not necessarily all referring to the same embodiment. Furthermore, the particular features, structures, methods, or characteristics may be combined in any suitable manner in one or more embodiments. The words “including” and “having” shall have the same meaning as the word “comprising.”

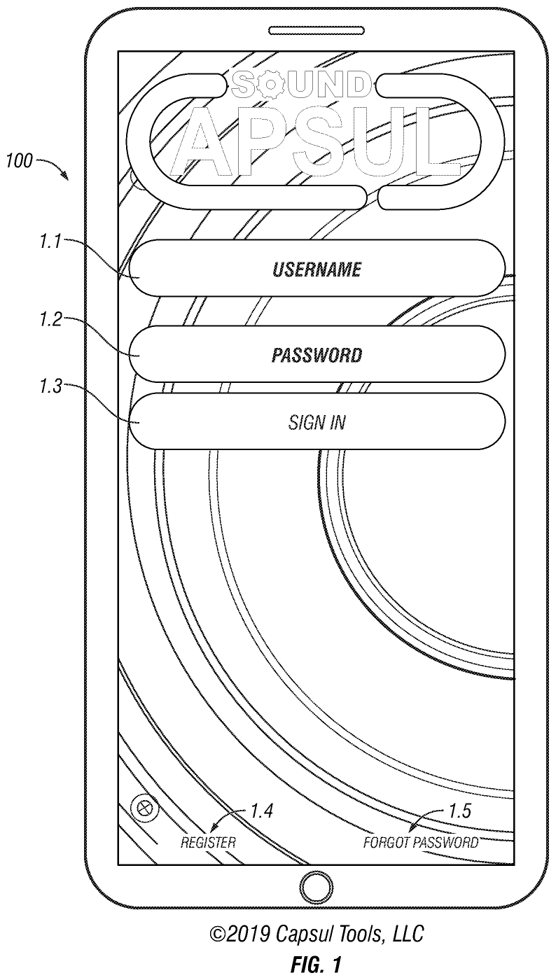

Referring now to the drawings, FIGS. 1-36 depict exemplary screen shots from, e.g., a smart phone device 100, displaying screen content from a mobile and web-based interactive software application or app referred to herein as the “Sound Capsul” app or “the app” or “the application” when the system is used according to embodiments of the present disclosure. These screen shots are more particularly summarized below.

FIGS. 1-3 illustrate an exemplary Sound Capsul sign in screen for a user to create his/her login credentials to login into the application. This screen mainly consists of a plurality of fields and buttons such as Username (1.1), Password (1.2), sign in button (1.3), Register button (1.4) and Forgot password button (1.5) to access the application. The username (1.1) field is used by existing account holders, and if not an existing user the new user needs to click on the registration button (1.4) to complete the registration process and Sign (1.3) into the application to access it.

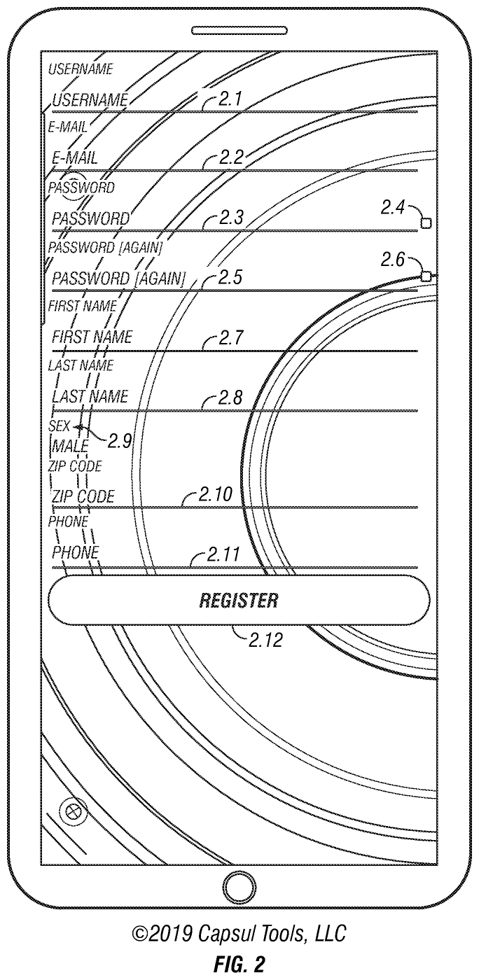

If the user is existing account holder then the user can directly sign in to the application by clicking on the sign in button (1.3), if not existing user, a new user must click on the Registration button (1.4) to complete the registration process. The registration screen as shown in FIG. 2 comprises a plurality of fields to be completed such as user name (2.1) where the selected username is entered, E-mail (2.2) where the user inputs the e-mail address to be associated with the user's account, Password input 1 (2.3) where a new user would insert the desired password for use in conjunction with the username in order to access the user's account, Password view 1 (2.4) which permits the user to toggle between having the user's password input 1 entry visible or invisible on the screen so that the user can confirm correct entry of the password, Password conformation input (2.5) where the new user would re-enter the chosen password allowing the system to confirm that both iterations were consistent, Password view 2 (2.6) which permits the user to toggle between having the user's password input 1 entry visible or invisible on the screen so that the user can confirm correct entry of the password, First name (2.7), Last name (2.8), sexual pronoun (2.9), zip code (2.10) of, e.g., the user's primary residence, Phone number (2.11) to be associated with the user's account. After completing the requisite input fields, the account Register button (2.12) becomes activated permitting the user to submit the data to activate the account.

If the user is an existing user and desires to enter into the application, then the user needs to fill in Username field (1.1) along with Password field (1.2), then the sign in button (1.3) becomes active and then allows for entry into app.

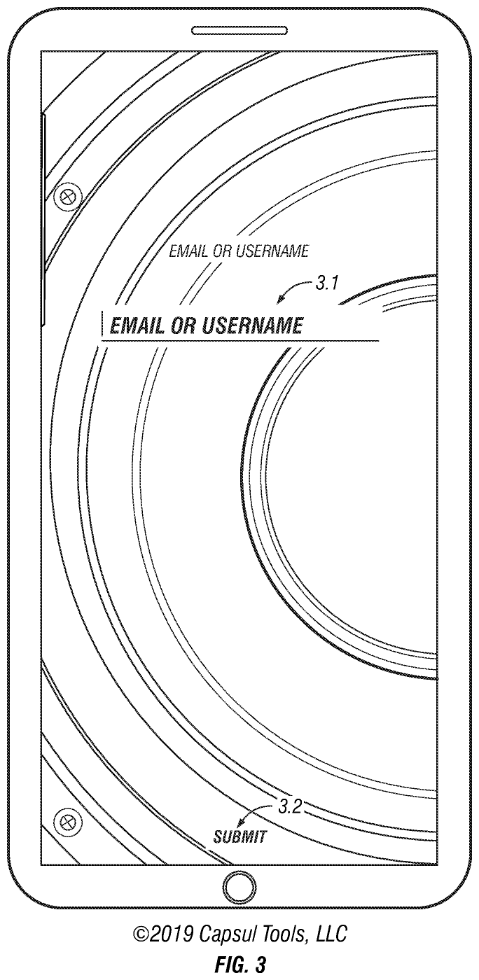

If the user doesn't have an account, then the user needs to click on the Registration button (1.4). This button shifts to a page as shown in FIG. 2 which allows the user to create an account. After creating the account, if user forgets the user password, then the user needs to click on the forget Password button (1.5). This button takes the user to a page such as shown in FIG. 3 and allows an existing user to request a link enabling the user to change the user's password. Referring to the email or username field (3.1), the user can place the email address or the username associated with the account in order to recover account or reset credentials. One or the other needs to be entered in order to reset credentials. Once the requisite fields have been completed, the submit button (3.2) becomes active, the user can then submit the data and access a link that provides the user with access to the credential s associated with the account.

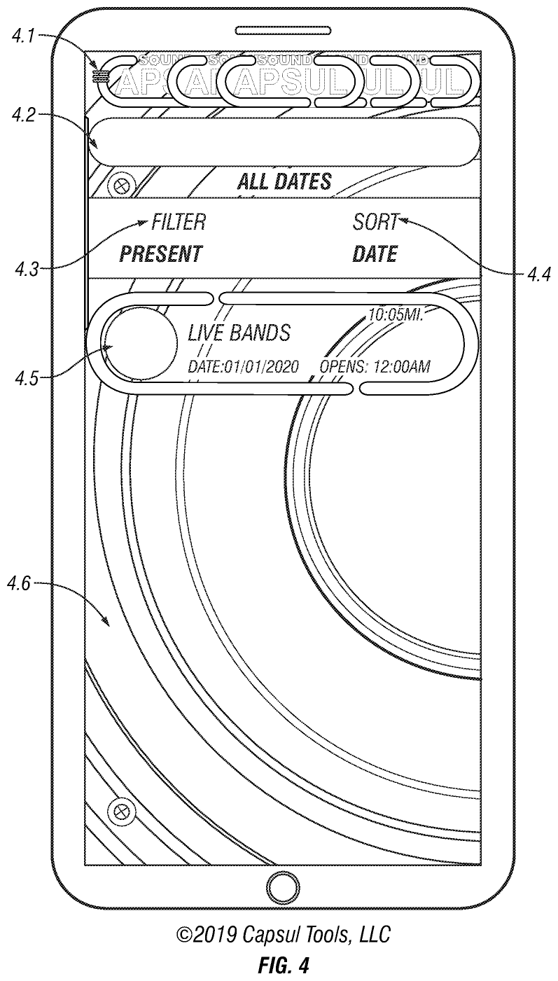

FIG. 4 is a Sound Capsul app home screen where user is provided with several options to perform several functions. After creating an account, and logging into the account, a home page with several options is visible to the user in the application. The home screen is provided with plurality of buttons such as a side menu button (4.1) which opens up the user side menu, a search field (4.2) where user can search in the app based on criteria such as Events, Artist, Location, Venue, Promoter, Genre, or Bout. An event filter button (4.3) allows the user to filter between currently available events in the app and events in the app history. An event sort button (4.4) allows the user to sort events over a period of time or a specific date. An event detail button (4.5) takes the user to the event detail screen and a Sound Capsul information window (4.6) which displays all the available options in a scroll menu for the users.

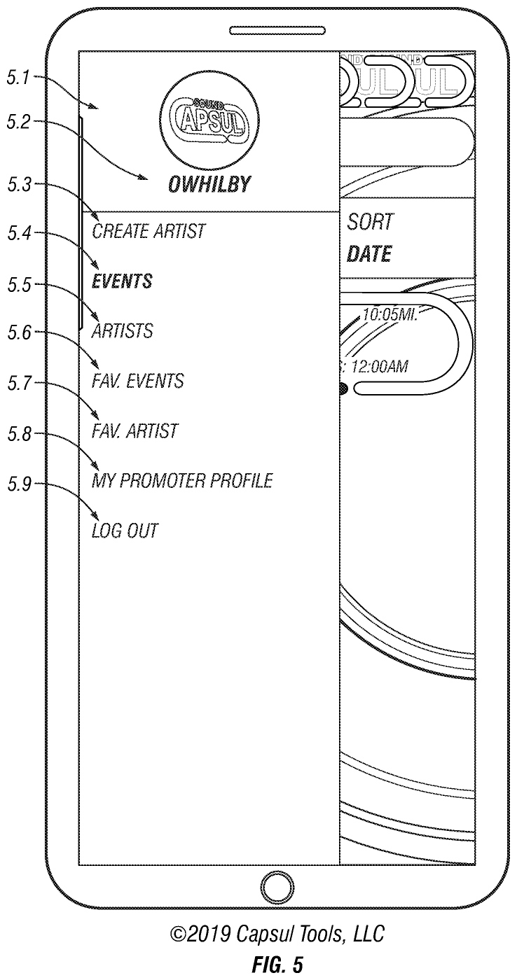

FIG. 5 shows side menu tab now open (after pressing the side menu button (4.1) from FIG. 4 for the users which is provided on the Sound Capsul home screen). On entering into the home screen as shown in FIG. 4 user is provided with several options one is side menu button (4.1) which when pressed then displays a plurality of fields with different functionalities as shown in FIG. 5. The side menu comprises fields like User Primary Profile Image Button (5.1) where user can view their current profile image. By clicking the button (5.1) the user can change the image associated with their primary profile.

A User Primary Profile Edit Button (5.2) is also provided to allow the user to edit the user profile information. A Sound Capsul Artist Profile Creation Button (5.3) is provided and when clicked, it takes the user to the “Sound Capsul Artist Profile Creation Page”, where the user can create an artist profile. Additionally, a Sound Capsul Event Home Screen Button (5.4) is provided and when clicked, the user is directed back to the “Sound Capsul Home Screen”. A Sound Capsul Artist Button (5.5) is also provided that directs the user to the “Sound Capsul Artist List” where the user has the ability to listen to the music any artist has uploaded to the app.

A Sound Capsul Favorite Event Button (5.6) is also provided and when pressed, takes the user to a list of events the user has designated as the user's favorites, allowing the user to purse past and future details for these events. A Sound Capsul Favorite Artist Button (5.7) is provided to direct the user to a list of artists the user has designated as the user's favorites. A Secondary Profile Button (5.8) directs the user to the “Sound Capsul Artist Profile Page” where the user can edit the information associated with that profile. A Log Out Button (5.9) can be pressed to log the user out of the “Sound Capsul” application.

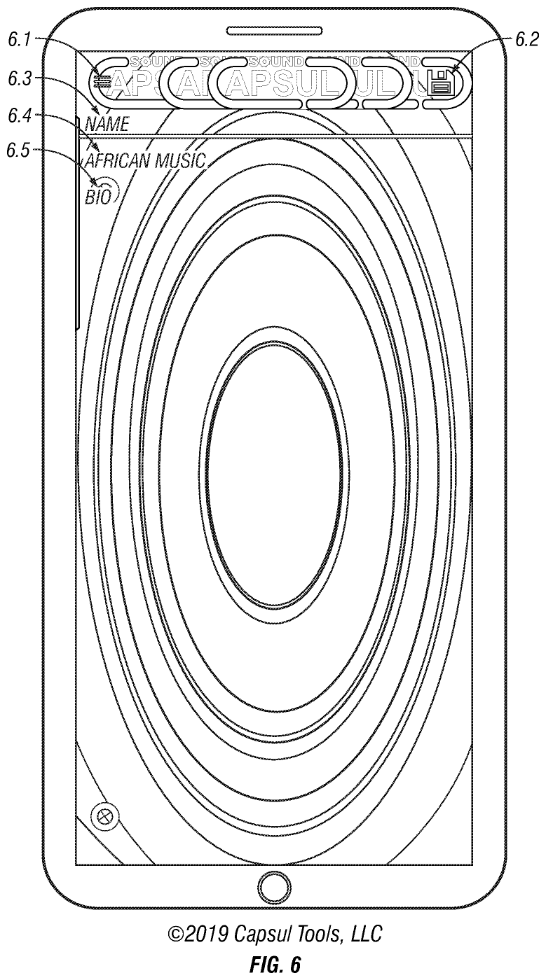

FIG. 6 is a Sound Capsul artist profile creation page where an artist can enter complete details about the artist. In this profile creation page, the user (here, an artist) is provided with a plurality of fields where the user can provide the required details. The fields on this screen include: a Side Menu Button (6.1) to open up the Sound Capsul Side Menu; an Information Save Button (6.2) which when pressed will save the information; a Sound Capsul Artist Name Field (6.3) where the user would place the artist user name associated with the “Sound Capsul Artist Profile”; an Artist Genre Selection List (6.4) that when clicked takes the user (artist) to a drop down menu where the user can select the genre of music performed by the artist; and an Artist Bio Field (6.5) where the user (artist) can input biographical data for the artist's “Sound Capsul Profile”.

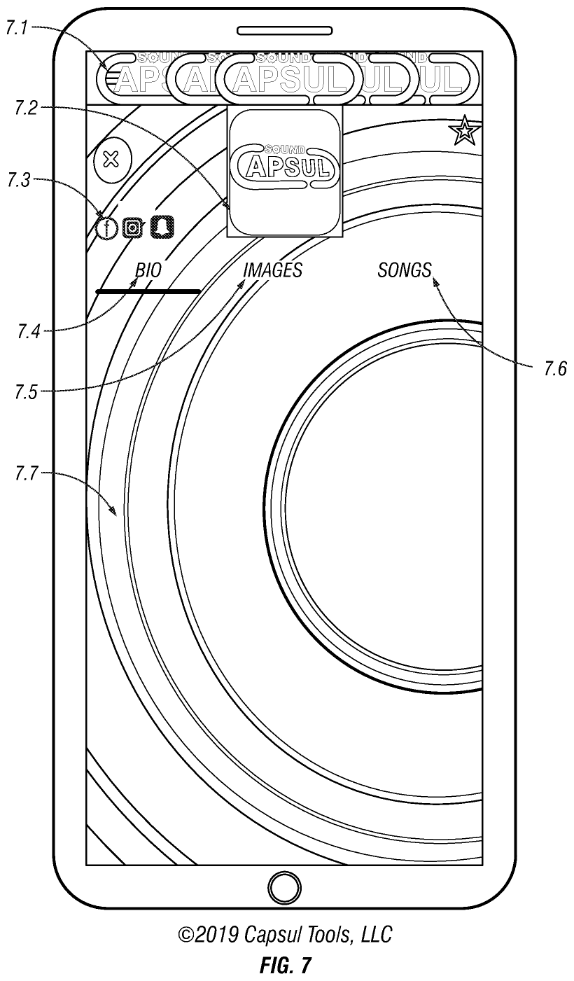

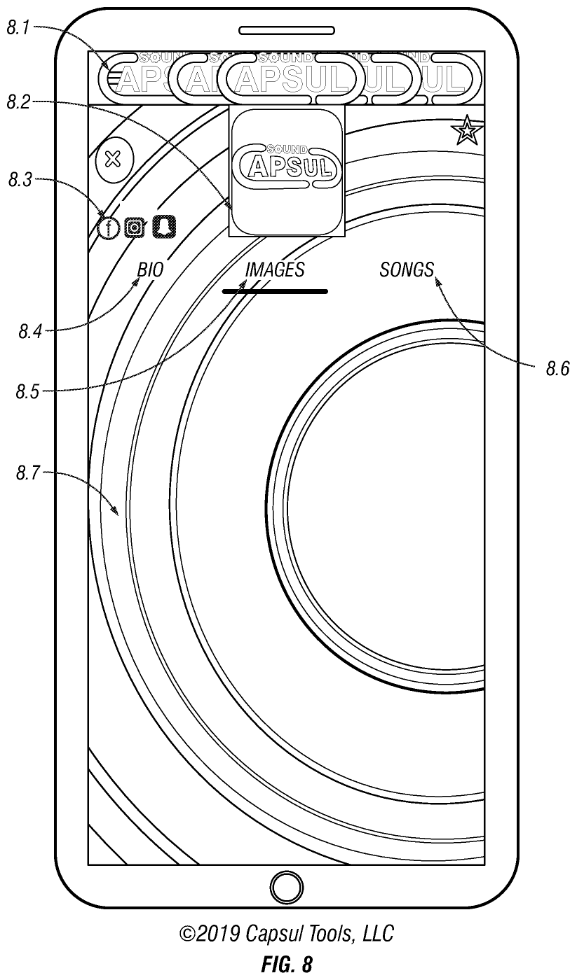

FIG. 7 depicts an exemplary artist bio page. On this screen, the side menu button (7.1) opens up the user side menu. When the user presses the artist profile picture window button (7.2), the use can the add to or edit the image associated with the user's profile. An artist social media portal (7.3) is provided to permit the user to connect the user's social media identities into the Sound Capsul experience. An artist bio field button (7.4) permits the user to input a short bio for other Sound Capsul users. This is the default view when a user opens an artist “Sound Capsul” page. An artist image gallery button (7.5) permits, when pressed, the user to open an artist image gallery. The artist music library button (7.6) provides the user with access into the Sound Capsul Artist Music Library which functions as a repository for the artist music that the artist has placed into the Sound Capsul and has designated as for the public. The Sound Capsul information window button (7.7) displays the information for whichever button the user has selected. In this particular view, the default screen is the information for the artist Bio.

FIG. 8 depicts an artist gallery page. On this screen, the side menu button (8.1) opens up the user side menu. When the user presses the artist profile picture window button (8.2), the user can then add to or edit the image associated with the user's profile. An artist social media portal (8.3) is provided to permit the user to connect the user's social media identities into the Sound Capsul experience. An artist bio field button (8.4) permits the user to input a short bio for other Sound Capsul users. This is the default view when a user opens an artist “Sound Capsul” page. An artist image gallery button (8.5) permits, when pressed, the user to open an artist image gallery. The artist music library button (8.6) provides the user with access into the Sound Capsul Artist Music Library which functions as a repository for the artist music that the artist has placed into the Sound Capsul and has designated as for the public. The Sound Capsul information window button (8.7) displays the information for whichever button the user has selected. In this particular view, the default screen is the information for the artist bio, but this window is showing the “Images”.

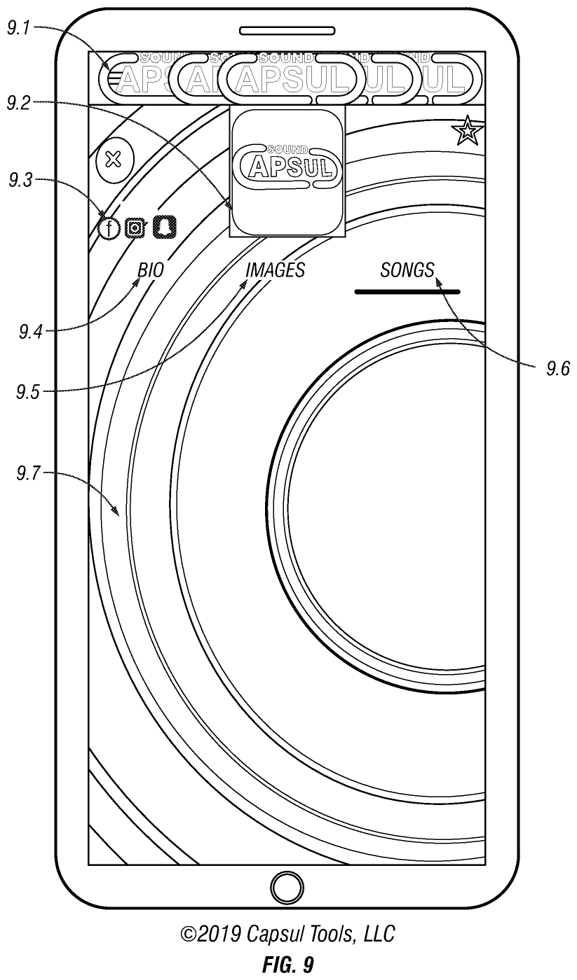

FIG. 9 depicts an artist music catalog page. On this screen, the side menu button (9.1) opens up the user side menu. When the user presses the artist profile picture window button (9.2), the user can then add to or edit the image associated with the user's profile. An artist social media portal (9.3) is provided to permit the user to connect the user's social media identities into the Sound Capsul experience. An artist bio field button (9.4) permits the user to input a short bio for other Sound Capsul users. This is the default view when a user opens an artist “Sound Capsul” page. An artist image gallery button (9.5) permits, when pressed, the user to open an artist image gallery. The artist music library button (9.6) provides the user with access into the Sound Capsul Artist Music Library which functions as a repository for the artist music that the artist has placed into the Sound Capsul and has designated as for the public. The Sound Capsul information window button (9.7) displays the information for whichever button the user has selected. In this particular view, the default screen is the information for the artist bio, but this window is showing the “Songs”.

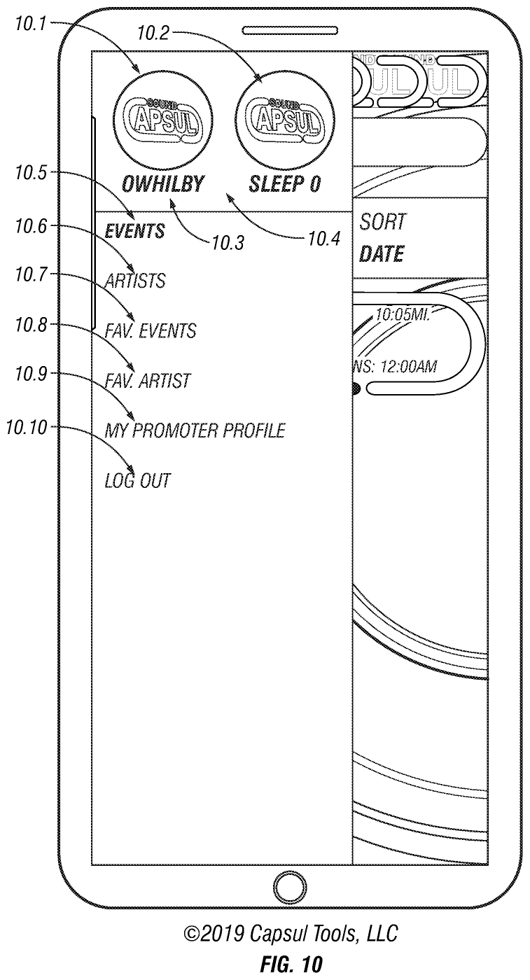

FIG. 10 is a side menu tab of a Sound Capsul with a plurality of fields. In the side menu a plurality of fields with several functions are provided. For example, a Sound Capsul Primary Profile Image Button (10.1) is provided in this field to permit a user to view the user's current profile image. When pushed, this button allows the user the ability to change the image associated with the user's primary profile. A Sound Capsul Artist Profile Image Button (10.2) accessed from this field provides a user with the ability to view the user's secondary account image. When pushed this button allows the user the ability to change the image associated with the user's secondary profile. A Sound Capsul Primary Profile Edit Button (10.3), when pressed, directs the user to a page where the user is able to edit the user's profile information.

A Sound Capsul Artist Profile Edit Button (10.4) is also displayed, and when pressed, this button takes the user to a page where the user can edit the user's secondary profile information. A Sound Capsul Event Home Screen Button (10.5) is also provided to direct the user back to the “Event Home Screen”. An Artist Button (10.6) is provided to take the user to the “Sound Capsul Artist List” where the user has the ability to listen to the music any artist has uploaded to the app. A Favorite Event Button (10.7) is provided and when pressed, this button takes the user to a list of events the user has designated as the user's favorites and allows the user to peruse past and future details for the event.

A Favorite Artist Button (10.8) is also provided and when pressed, this button takes the user to a list of artists the use has designated as the user's favorites. A Sound Capsul Artist Profile Button (10.9) is also display, and when pressed, this button takes the user to the “Secondary Profile Page” where the user can edit the information associated with the user's secondary profile. A Log Out Button (10.10) is also displayed and when pressed, this button logs the user out of the “Sound Capsul” app.

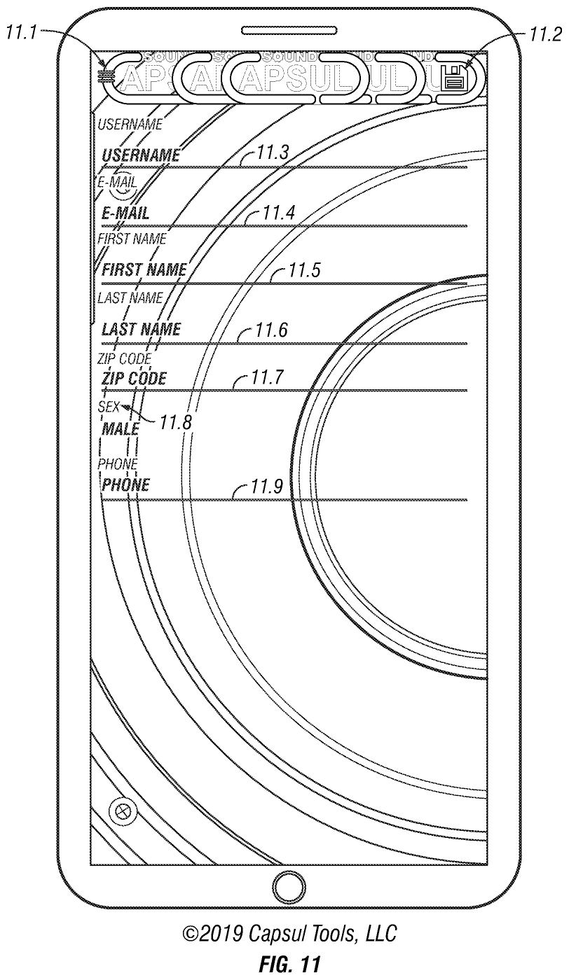

FIG. 11 is a Sound Capsul profile edit screen where the user can edit the user's profile. This profile edit screen contains a plurality of fields for editing or updating the profile wherein the fields include a Side Menu Button (11.1) to open up the user side menu, a Save Button (11.2) to save the changes the user has made to the user's profile data, a Sound Capsul Username Entry Field (11.3) where the user can change in this field the username associated with the account, a User Email Entry Field (11.4) where in this field the user can change the email address associated with the user's account, a User First Name Entry Field (11.5) where in this field the user has the ability to change the first name associated with the use's account, and a User Last Name Entry Field (11.6) where the user has the ability to change the last name associated with the user's account. A Zip Code Edit Entry Field (11.7) is provided to permit the user to change the zip code associated with the user's account. A User Gender Orientation Field (11.8) is also provided to allows the user to choose from a list of gender orientations to describe the user. A User Phone Number Field (11.9) is set out so that in this field the user has the ability to change the phone number associated with their account.

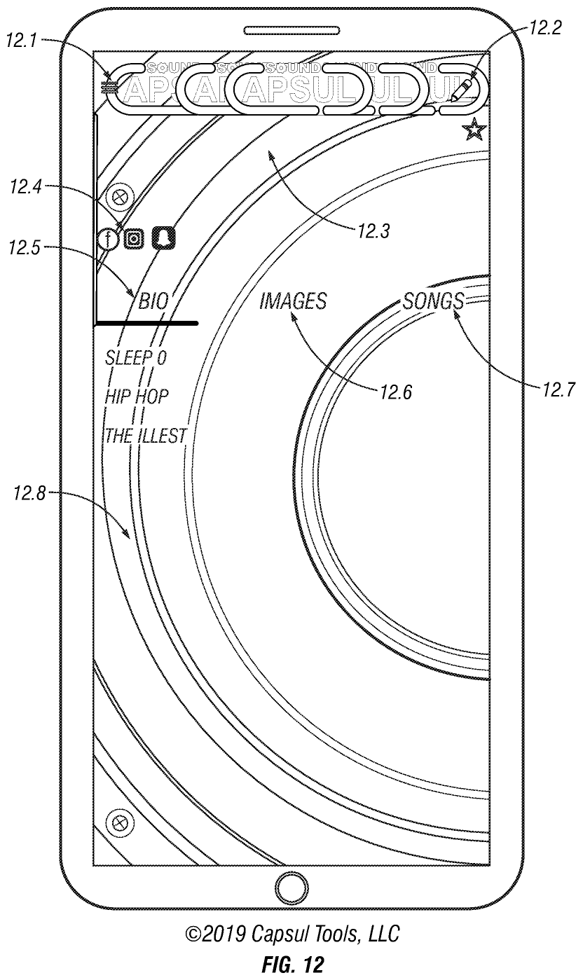

FIG. 12 is a Sound Capsul artist profile edit page where the artist associated with the application can edit his/her profile. This page contains a plurality of fields through which an artist can edit his/her profile, the plurality of fields including, a Side Menu Button (12.1) to open up the user side menu, a Field Information Edit Button (12.2) to allow the user to edit the data within the “Artist Sound Capsul Information Window” currently being viewed, and a Sound Capsul Artist Profile Picture Edit Button (12.3) to permit the user to change the profile image associated with the user's “Artist Sound Capsul Page”.

A Social Medial Link Button (12.4) is also provided to allow the user to connect the user's various social media outlets to their “Artist Sound Capsul” account, and a Sound Capsul Artist Bio Screen Button (12.5) is provided that when pressed, will take the user to the artist bio window where the user can edit the information associated with the user's “Artist Sound Capsul Bio”. This is the default information displayed in the “Artist Sound Capsul Information Window” (as is shown in this figure). A Sound Capsul Artist Image Gallery Screen button (12.6) is provided to permit the user to access a page where the user can add images to the user's “Sound Capsul” account. A Sound Capsul Artist Music Edit Page button (12.7) is provided and when pressed, this button takes the user to a page where the user has the ability to add music to the use's “Artist Sound Capsul Profile”. A Sound Capsul Information Window (12.8) displays whichever artist Sound Capsul profile button the user has pressed. By default, it displays the “Artist Sound Capsul Bio” information as shown.

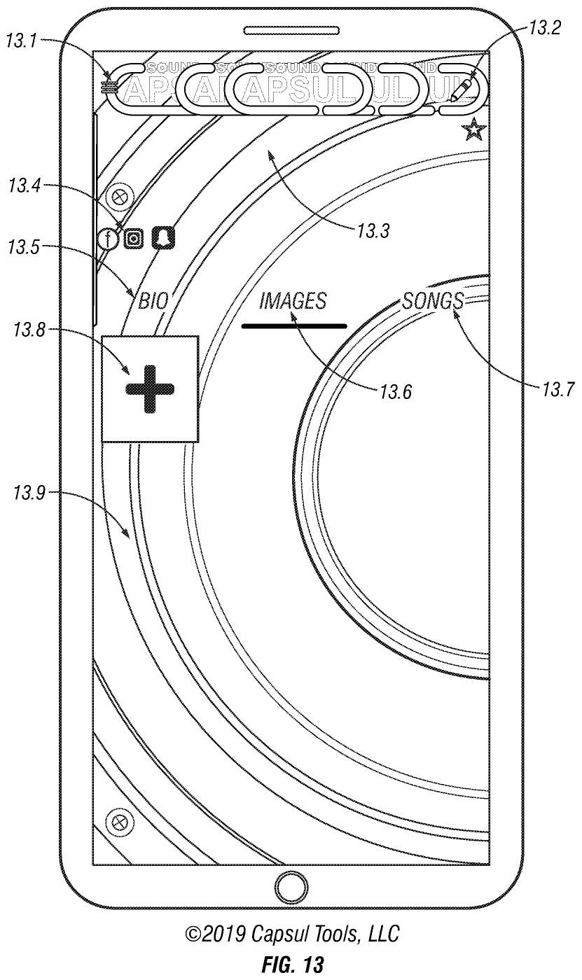

FIG. 13 is a Sound Capsul artist gallery page where an artist can perform several functions through the provided fields. The Sound Capsul artist gallery page includes a Side Menu Button (13.1 to open up the user side menu, a Field Information Edit Button (13.2) which allows the user to edit the data within the “Artist Sound Capsul Information Window” currently being viewed, a Sound Capsul Artist Profile Picture Edit Button (13.3) which allows the user to change the profile image associated with the user's “Artist Sound Capsul Page”, a Social Medial Link Button (13.4) which allows the user to connect the user's various social media outlets to the user's “Artist Sound Capsul” account.

A Sound Capsul Artist Bio Screen Button (13.5) is also provided and when pressed this button takes the user to the artist bio window where the user can edit the information associated with the user's “Artist Sound Capsul Bio”. This is the default information displayed in the “Sound Capsul Information Window” (13.9). Also displayed are: a Sound Capsul Artist Image Gallery Screen button (13.6) which when pressed takes the user to a page where the user can add images to the user's “Sound Capsul Galley”, a Sound Capsul Artist Music Edit Page (13.7) which when pressed directs the user to a page where the user has the ability to add music to the user's “Sound Capsul Artist Profile”, a Sound Capsul Artist Gallery Image Add Button (13.8) which when pressed takes the user to a link where the user is able to add images to the user's “Sound Capsul Gallery”, and a Sound Capsul Information Window (13.9) which will display whichever artist Sound Capsul profile button the user has pressed. By default, it displays the “Artist Sound Capsul Bio” information, but as shown in this view, the “images” content is displayed. In this view it provides a scrolling view of the artist gallery.

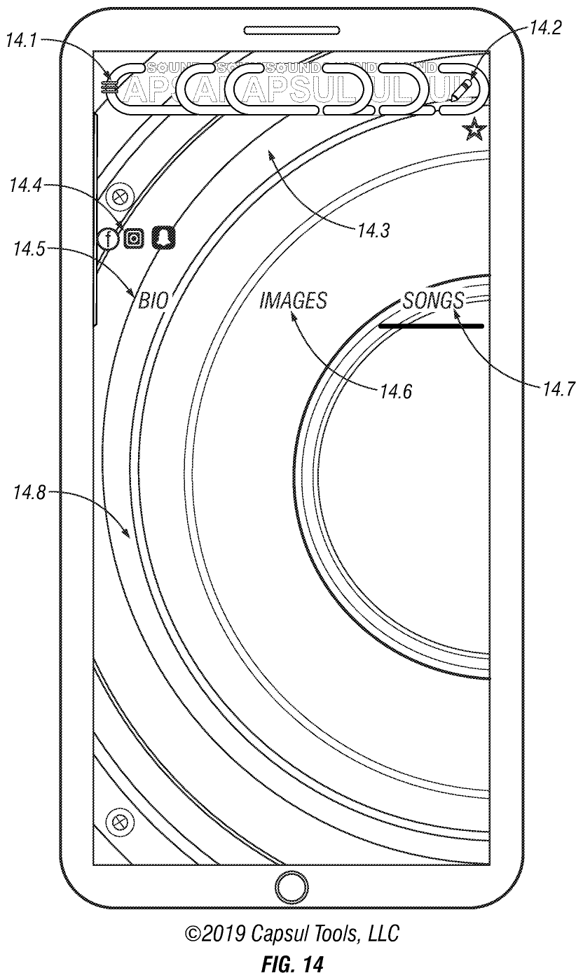

FIG. 14 is a Sound Capsul music page where artists can upload their songs. This music page comprises a Side Menu Button (14.1) that opens up the user side menu, a Field Information Edit Button (14.2) that allows the user to edit the data within the “Artist Sound Capsul Information Window” currently being viewed, a Sound Capsul Artist Profile Picture Edit Button (14.3) to permit the user to change the profile image associated with the user's “Artist Sound Capsul Page”, and a Social Medial Link Button (14.4) which allows the user to connect their various social media outlets to their “Artist Sound Capsul” account.

A Sound Capsul Artist Bio Screen Button (14.5) is also displayed and when pressed, this button takes the user to the artist bio window where the user can edit the information associated with their “Artist Sound Capsul Bio”. This is the default information displayed in the “Sound Capsul Information Window”. A Sound Capsul Artist Image Gallery Screen button (14.6) is provided and when pressed this button takes the user a page where they can add images to the user's “Sound Capsul” account. A Sound Capsul Artist Music Edit Page button (14.7) is likewise displayed, and when Pressed this button takes the user to a page where the use has the ability to add music to the user's “Sound Capsul Artist Profile”. Also, in this view, the Sound Capsul Information Window (14.8) will display whichever tab the user has selected with in the “Sound Capsul Artist Profile”, and by default it displays the “Sound Capsul Artist Bio” information (but the “Songs” content is displayed in this view).

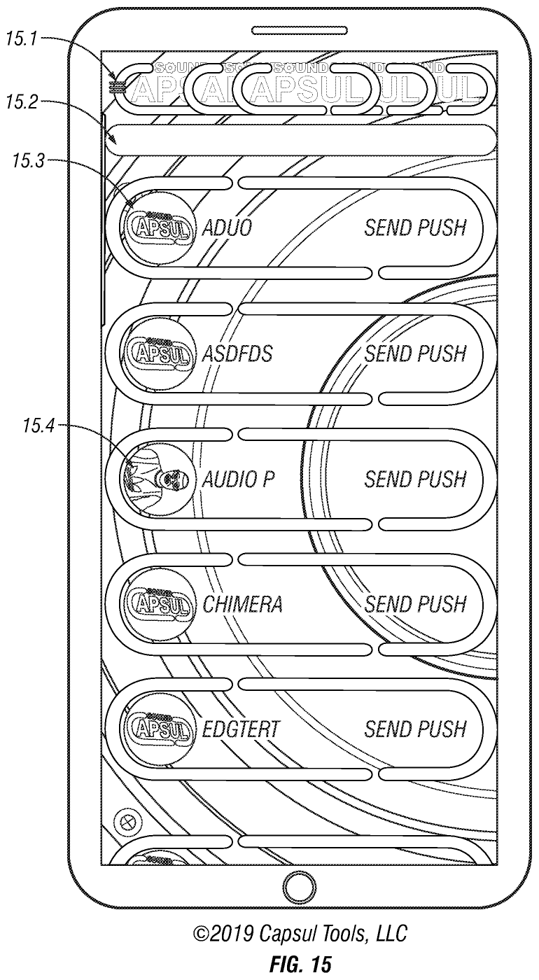

FIG. 15 is a Sound Capsul artist list page where the user can find a plurality of artists associated with the application. This artist list page comprises a plurality of fields such as a Side Menu Button (15.1) to open up the user side menu, a Sound Capsul Search Field button (15.2) to permit searching in the app based on criteria such as: Events, Artist, Location, Venue, Promoter and Genre or Bout. A Sound Capsul Artist Page Button (15.3) is provided such that when pressed, this button takes the user to the “Sound Capsul Artist Profile” associated with artist selected by the user. In this view, the Sound Capsul information Window (15.4) provides a scrollable list of “Sound Capsul Artists”.

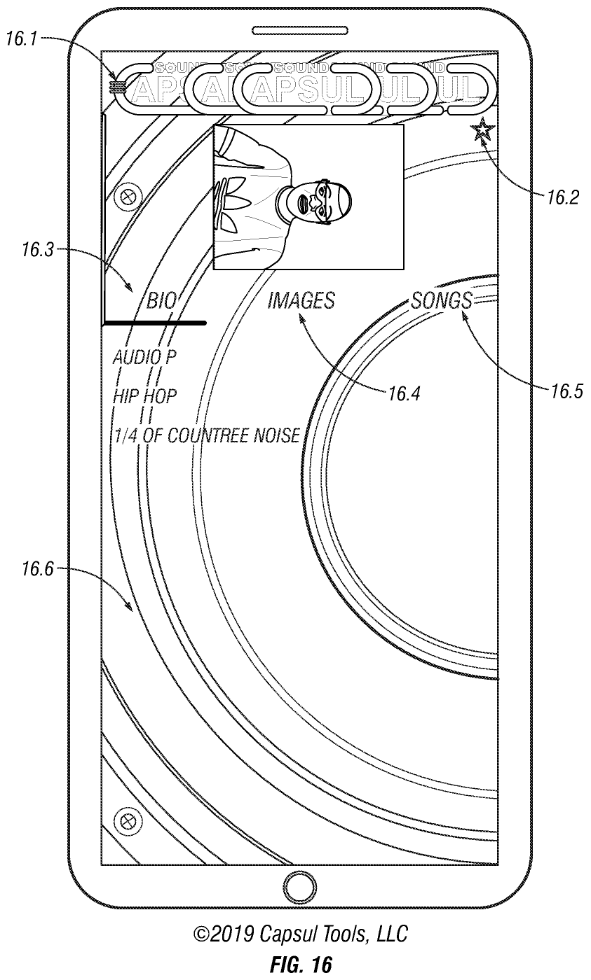

FIG. 16 is a Sound Capsul artist page for the artist “Audio P” displayed in the prior screen (FIG. 15), and displaying the artist's image at the top. The use can, much like described previous, navigate this page by using the plurality of fields provided on the page. In this page the user is provided with a plurality of fields such as a Side Menu Button (16.1) to open up the user side menu, a Favorite Artist Button (16.2) to toggle between adding or removing an artist from the user's favorite's list, a Sound Capsul Artist Bio Field (16.3) displaying (as shown here) biographical information of the artist and is the default view when the user opens an artist “Sound Capsul” page. Also provided is a Sound Capsul Artist Image Gallery Button (16.4) which when pressed slides the user into the artist “Image Capsul”.

A Sound Capsul Artist Music Library Button (16.5) is also provided and when pressed, this button slides the user into the artist “Sound Capsul Music Library” which functions as a repository for the artist music the artist has in “Sound Capsul” and has designated for the public. In this view, the Sound Capsul information Window (16.6) displays the information for whichever button the user has selected. The default screen for the Artist Page displays the information for the artist bio as shown.

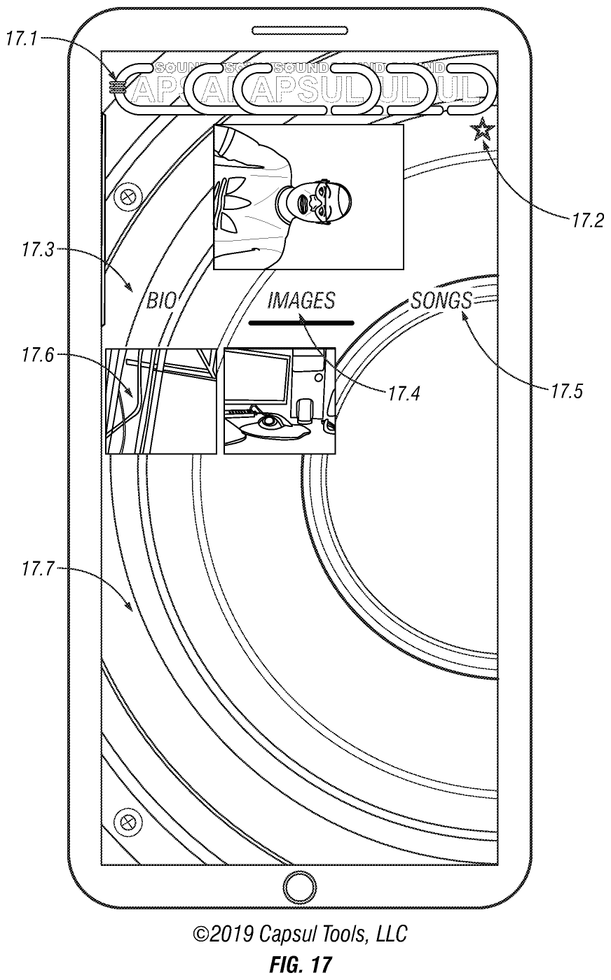

FIG. 17 is a Sound Capsul artist gallery page where user can select the favorite artist from the provided list. This page comprises a plurality of fields include a Side Menu Button (17.1) this button opens up the user side menu, a Favorite Artist Button (17.2) this toggle button adds or removes an artist from the users favorite's list, a Sound Capsul Artist Bio Field (17.3) this field displays the artist biographical information and is the default view when you open an artist “Sound Capsul” page, a Sound Capsul Artist Image Gallery Button (17.4) when pressed this button slides the user into the artist “Image Capsul”.

A Sound Capsul Artist Music Library Button (17.5) is also provided and when pressed, this button slides the user into the artist “Sound Capsul Music Library” which functions as a repository for the artist music the artist has in “Sound Capsul” and has designated for the public. A Sound Capsul Artist Gallery Images button (17.6) is provided to permit access to the images loaded by the artist. Each image acts as an active button, and when pressed, provides a full screen view of the image. The Sound Capsul information Window (17.7) displays the information for whichever button the user has selected. In this view it provides a scrollable list of artist images as shown.

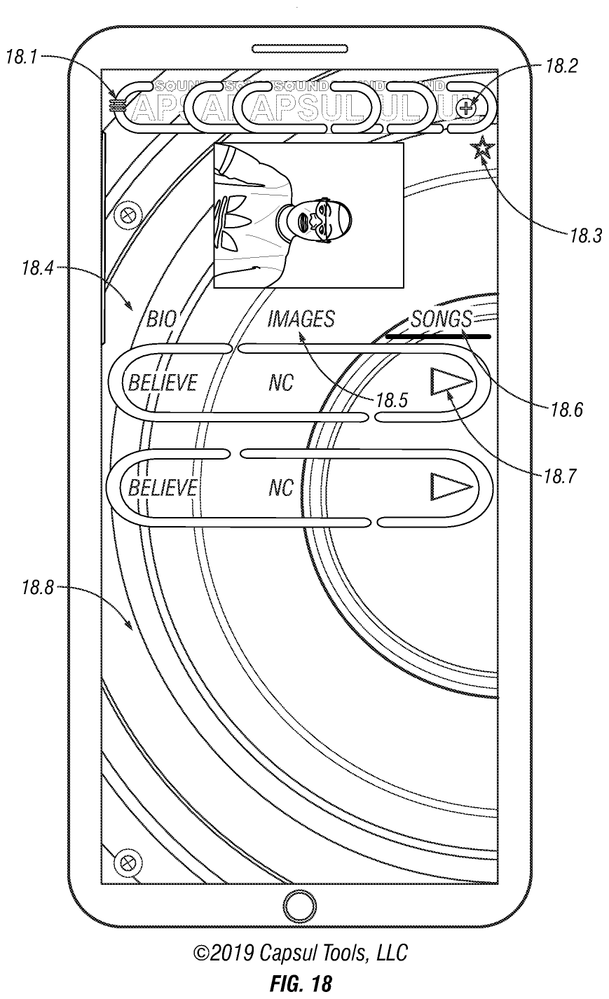

FIG. 18 is a Sound Capsul artist music library page where an artist can add the artist's music and users can listen the music. This page comprises a plurality of fields for the artist and users where both can access the page. The fields include a Side Menu Button (18.1) to open the user side menu. A Field Information Addition Button (18.2) is only available for the artist profile currently logged in, and allows the user to add data within the “Artist Sound Capsul Information Window” currently being viewed. In this view, the add button would allow the user to add more music. A Favorite Artist Button (18.3) is provided that allows the user to toggle between adding and removing an artist from the “Favorites” list. A Sound Capsul Artist Bio Field button (18.4) permits access to a page displaying the artist's biographical information and is the default view when a user opens the app to an artist “Sound Capsul” page.

A Sound Capsul Artist Image Gallery Button (18.5) is provided and when pressed, this button slides the user into the artist “Image Capsul”. A Sound Capsul Artist Music Library Button (18.6) is provided and when pressed this button slides the user into the artist “Sound Capsul Music Library” which functions as a repository for the artist's music in “Sound Capsul” designated by the artist for the public. An Artist Track Play Button (18.7) is provided and when pressed, this button allows the user to listen to the selected song offering from the artist. In this screen, the Sound Capsul information Window (18.8) displays the information for whichever button the user has selected, and in this view, it provides a scrollable list of the music the Artist has uploaded to the artist's “Sound Capsul Artist Profile”.

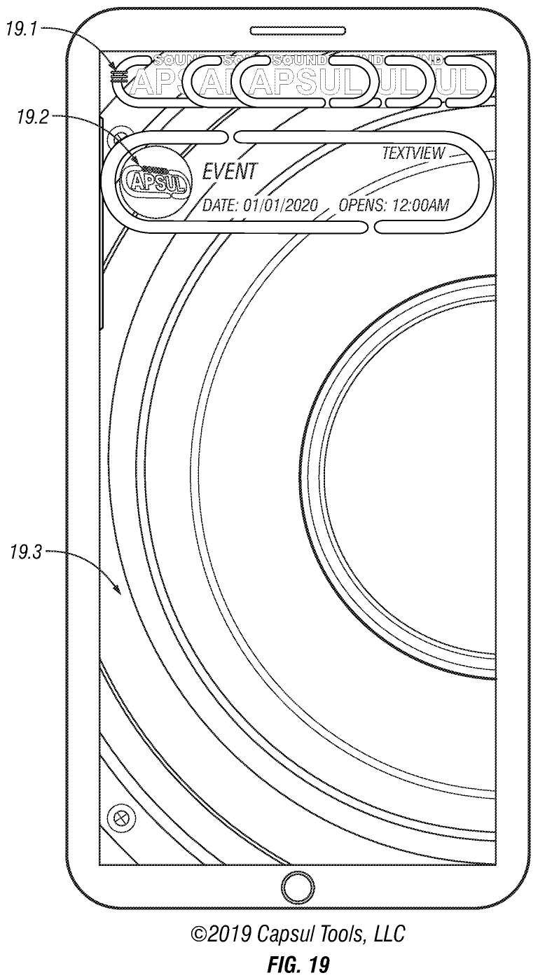

FIG. 19 shows an exemplary Sound Capsul favorite event list page which can be accessed by the user. This event list page comprises a plurality of fields such as Side Menu Button (19.1) that permits the use to open the user side menu, a Favorite Event Capsul Button (19.2) which when pressed, takes the user to the “Sound Capsul Page” associated with the event. Also provided is a Sound Capsul Event Information Window (19.3) which will display a list of events the user has designated as favorites.

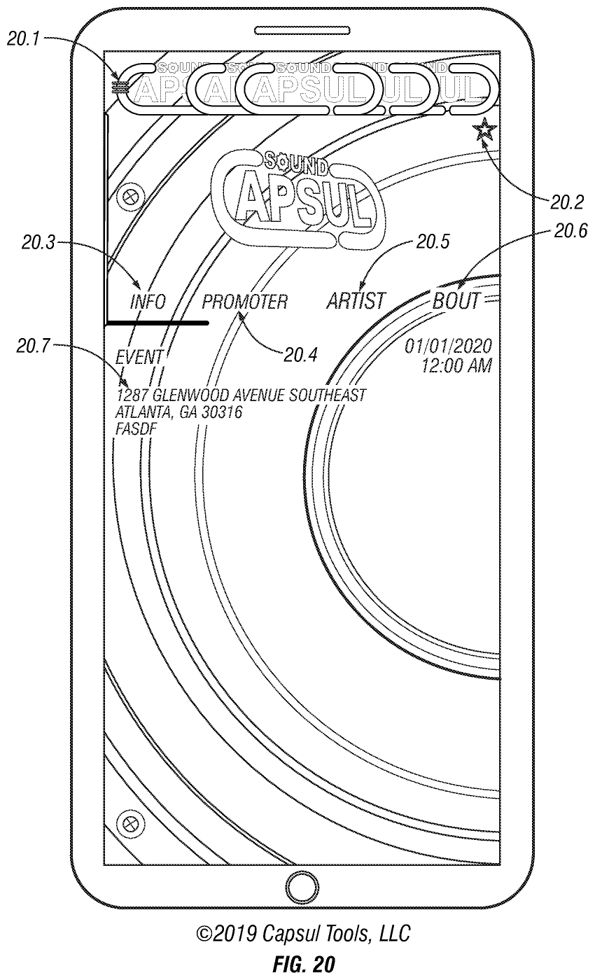

FIG. 20 is a Sound Capsul favorite event page where the page displays a plurality of events designated by the user to be “favorites”. The events page includes a Side Menu Button (20.1) to open up the user side menu, a Favorite Event Toggle Button (20.2) which when pressed, toggles an event between the status of favored and un-favored in the user's “Favorite Events” list accessible in the user's side menu. A Favorite Event Info Page Button (20.3), when pressed, displays the data recorded in the “Event Info button” displaying it in the “Sound Capsul Information Window” (20.7). This Data will be visible in the “Sound Capsul information Window” (20.7). A Sound Capsul Promoter Information Button (20.4) is also provided and when pressed, this button takes the user to the “Sound Capsul Page” associated with the promoter for the selected event. This Data will be visible in the “Sound Capsul information Window” (20.7).

A Sound Capsul Event Artist List Page Button (20.5) is also provided and when pressed, this button takes the user to a view which provides the user with a list of the artists associated with the particular event. This Data will be visible in the “Sound Capsul information Window”. An Event Bout Status Data Page Button (20.6) is also provide and when pressed, this button takes the user to a page where the user can view the user's “Bout” rating on the artist music associated with that particular event. This Data will be visible in the “Sound Capsul information Window”. A Sound Capsul Information Window (20.7) displays the information associated with the button the user has pressed. In its default view it shows the information for the “Info” button consisting of information about the event as shown here.

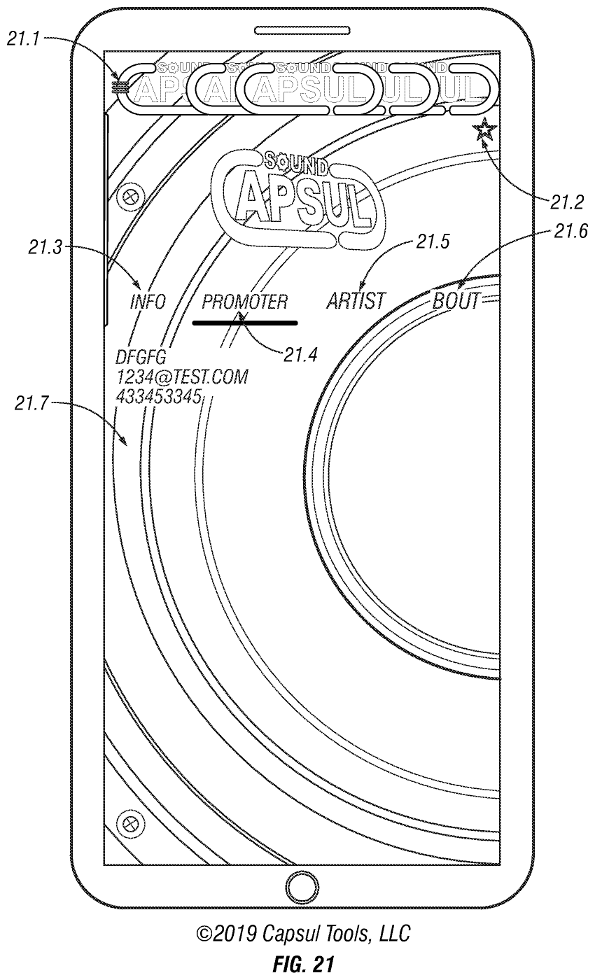

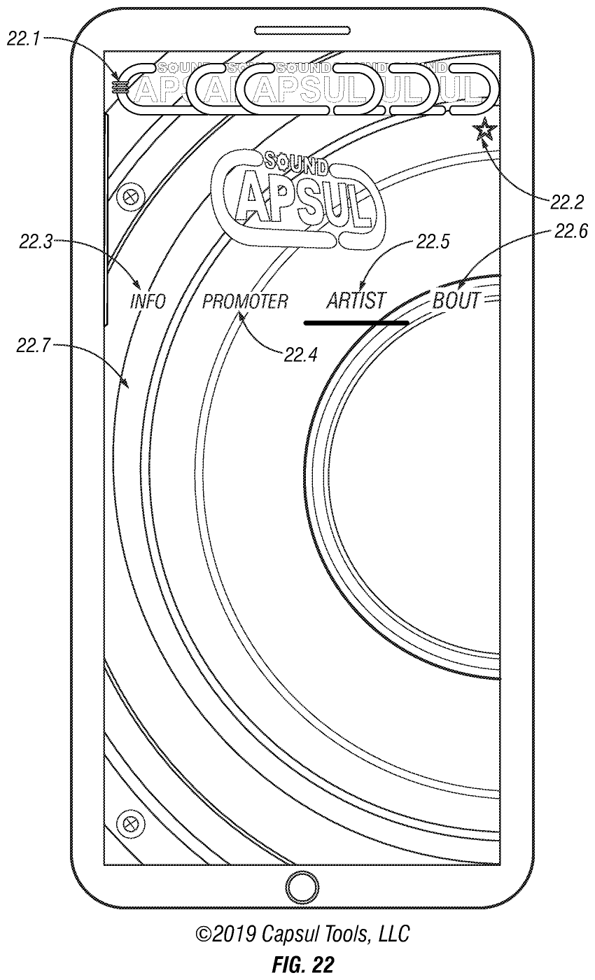

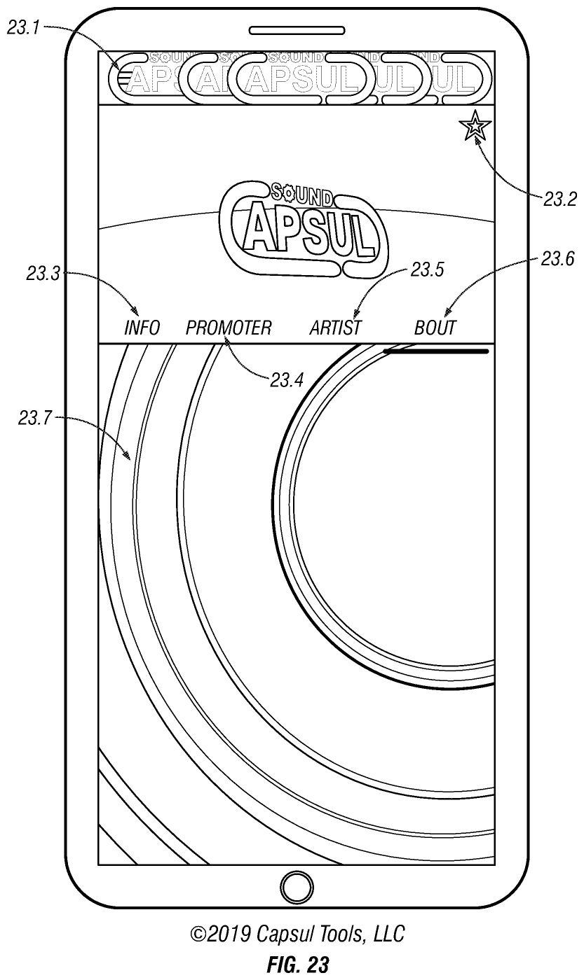

FIG. 21 is a favorite event promoter information page where the events that have the status of “favorites” are listed. This comprises a plurality of fields such as a Side Menu Button (21.1) to open up the user side menu, a Favor Event Toggle Button (21.2) which when pressed, toggles an event between the status of favored and un-favored in the user's “Favorite. Events” list accessible in the side menu. A Favorite Event Info Page Button (21.3) is also displayed and when pressed, this button displays the data recorded in the “Event Info button” displaying it in the “Sound Capsul Information Window” (19.7). This Data will be visible in the “Sound Capsul information Window”.

A Sound Capsul Promoter Information Button (21.4) is also provided and when pressed, this button takes the user to the “Sound Capsul Page” associated with the promoter for the selected event. This Data will be visible in the “Sound Capsul information Window”. Also, a Sound Capsul Event Artist List Page Button (21.5) is provided and when pressed this button takes the user to a view which provides the user with a list of the artists associated with the particular event. This Data will be visible in the “Sound Capsul information Window” (21.7). An Event Bout Status Data Page Button (21.6) is shown, and when pressed, this button takes the user to a page where the user can view the user's “Bout” rating on the artist's music associated with that particular event. This Data will be visible in the “Sound Capsul information Window”. A Sound Capsul Information Window (21.7) displays the information associated with the tab the user has selected. In its default view it shows the information for the “Info” tab consisting of information about the event. In this view it displays the information associated with the promoter.

FIG. 22 is a Sound Capsul favorite event artist list where the page displays the list of artists associated with the particular event. The favorite event artist list includes a Side Menu Button (22.1) that opens up the user side menu, a Favor Event Toggle Button (22.2) that when pressed, toggles an event between the status of favored and un-favored in the user's “Favored. Events” list accessible in the user's side menu. A Favorite Event Info Page Button (22.3) is provided and when pressed, this button displays the data recorded in the “Event Info button” displaying it in the “Sound Capsul Information Window” (22.7). This Data will be visible in the “Sound Capsul information Window”.

A Sound Capsul Event Promoter Information Button (22.4) is also display and when pressed, this button takes the user to the “Sound Capsul Page” associated with the promoter for the selected event. This Data will be visible in the “Sound Capsul information Window”. A Sound Capsul Event Artist List Page (22.5) is provided and when pressed, this button takes the user to a view which provides the user with a list of the artists associated with the particular event. This Data will be visible in the “Sound Capsul information Window”. An Event Bout Status Data Page Button (22.6) is shown and when pressed, this button takes the user to a page where the user can view the user's “Bout” rating on the artists' music associated with that particular event. This Data will be visible in the “Sound Capsul information Window”. A Sound Capsul Information Window (22.7) displays the information associated from the tab the user has selected. In its default view it shows the information for the “Info” tab consisting of information about the event. In this view it would display a list of artists associated with the event.

FIG. 23 is a favorite event Bout standings list where the user can view the Bout rating associated with that particular event. The event Bout standings list includes a plurality of fields such as a Side Menu Button (23.1) that opens up the users side menu, a Favor Event Toggle Button (23.2) which when pressed toggles an event between the status of favored and unfavored in the users “Favorite Events” list accessible in the user's side menu, a Favorite Event Info Page Button (23.3) which when pressed, displays the data recorded in the “Event Info button” displaying it in the “Sound Capsul Information Window” (23.7). This Data will be visible in the “Sound Capsul information Window”.

A Sound Capsul Promoter Information Button (23.4) is provided and when pressed, this button takes the user to the “Sound Capsul Page” associated with the promoter for the selected event. This Data will be visible in the “Sound Capsul information Window” (21.7). A Sound Capsul Event Artist List Page Button (23.5) is provided and when pressed, this button takes the user to a view which provides the user with a list of the artists associated with the particular event. This Data will be visible in the “Sound Capsul information Window”. An Event Bout Status Data Page Button (23.6) is provided and when pressed this button takes the user to a page where the user can view the user's “Bout” rating on the artist's music associated with that particular event. This Data will be visible in the “Sound Capsul information Window”. A Sound Capsul Information Window (23.7) displays the information associated from the tab the user has selected. In its default view it shows the information for the “Info” tab consisting of information about the event. In this view it displays a list of artists associated with the event along with the user's “Bout” ratings for each entry.

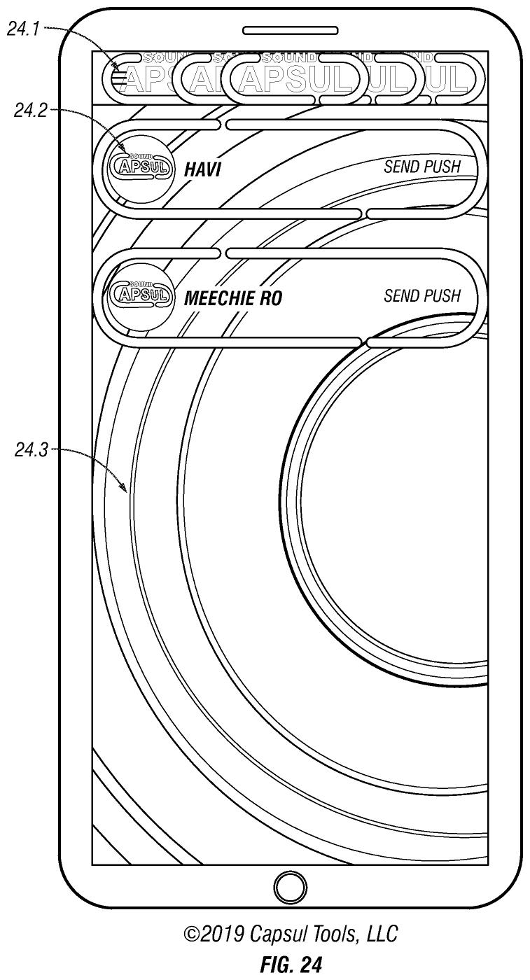

FIG. 24 is a Sound Capsul favorite artist list page where a user can choose the favorite artist. This favorite artist page includes a Side Menu Button (24.1) used to open up the user side menu, a Sound Capsul Artist Button (24.2) which when Pushed, will take the user to the “Sound Capsul” page associated with the artists. A Sound Capsul Information Window (24.3) displays the information associated the information tab the user has selected. In this view it provides a list of the artists the user has designated as favorite. This screen also provides a “Send Push” function for each of the listed artists.

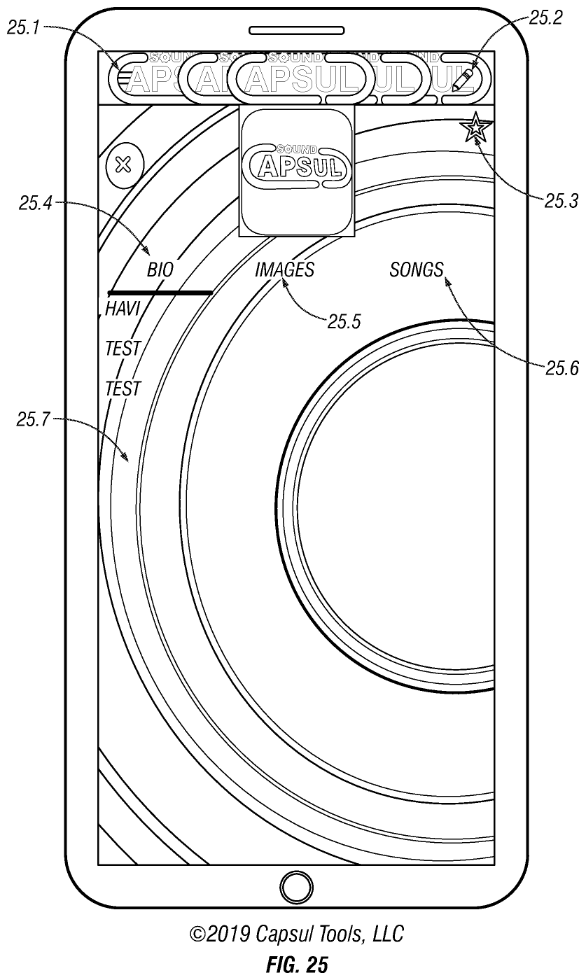

FIG. 25 shows a Sound Capsul favorite artist Biographical screen page where the user can see the biographical information of the selected artist. This page includes a Side Menu Button (25.1) for opening the user side menu. A Page Information Edit Button (25.2) visible and active if the user is viewing the Artist Sound Capsul page of the user currently signed in and allows the user to edit the information associated with the account and then save the changes. By default, it would allow for changes to the “Sound Capsul Artist Bio” tab. A Favorite Artist Button (25.3) toggles between adding or removing an artist from the user's favorite's list.

A Sound Capsul Artist Bio Field (25.4) this field displays the artist biographical information and is the default view when the user opens an artist “Sound Capsul” page. A Sound Capsul Artist Image Gallery Button (25.5) is provided and when pressed, this button slides the user into the artist “Image Capsul”. A Sound Capsul Artist Music Library Button (25.6) is provided and when pressed, this button slides the user into the artist “Sound Capsul Music Library” which functions as a repository for the artists music in “Sound Capsul” designated for the public. The Sound Capsul information Window (25.7) displays the information for whichever “Sound Capsul” field button the user is currently viewing. By default, it displays the information associated with the artist “Bio” tab as shown.

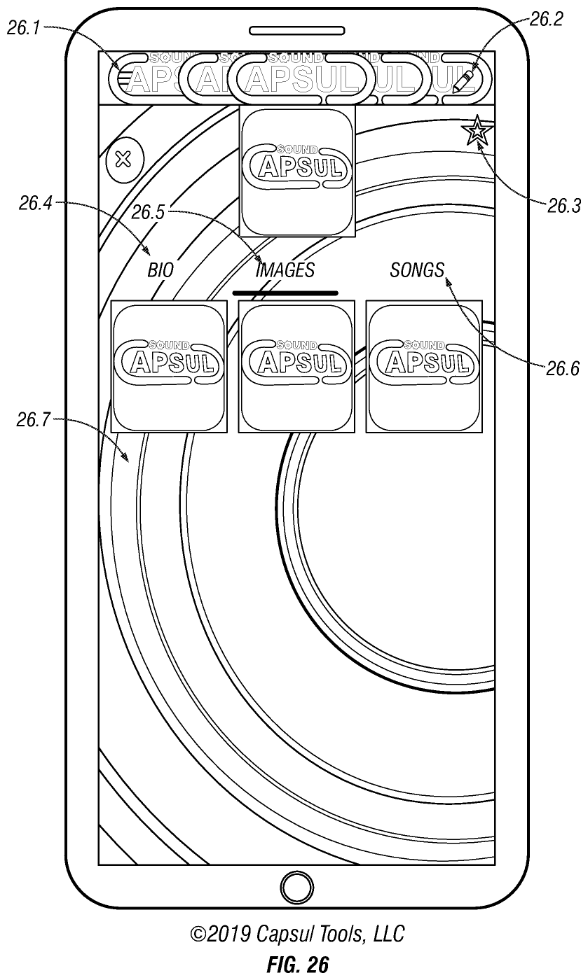

FIG. 26 is a Sound Capsul favorite artist Sound Capsul gallery page where the user can check the music uploaded by the artist. This page includes a Side Menu Button (26.1) to open the user side menu. A Page Information Edit Button (26.2) is provided and visible and active only if the user is viewing the Artist Sound Capsul page of the user currently signed in and allows the user to edit the information associated with the account and then save the changes. By default, it would allow for changes to the “Sound Capsul Artist Bio” tab. In this view it allows the user to add images to the “Sound Capsul Artist Image Gallery” (three example images being displayed).

A Favorite Artist Button (26.3) toggles between adding or removing an artist from the user's favorite's list. A Sound Capsul Artist Bio Field button (26.4) displays the artist biographical information and is the default view when opening an artist's “Sound Capsul” page. A Sound Capsul Artist Image Gallery Button (26.5) is provided and when pressed, this button slides the user into the artist “Image Capsul”. A Sound Capsul Artist Music Library Button (26.6) is also provided and when pressed, this button slides the user into the artist “Sound Capsul Music Library” which functions as a repository for the artist's music in “Sound Capsul” that has been designated for the public. The Sound Capsul information Window (26.7) displays the information for whichever “Sound Capsul” field button the user is currently viewing. By default, it displays the information associated with the artist “Bio” tab. In this view it displays the “Sound Capsul Artist Gallery”.

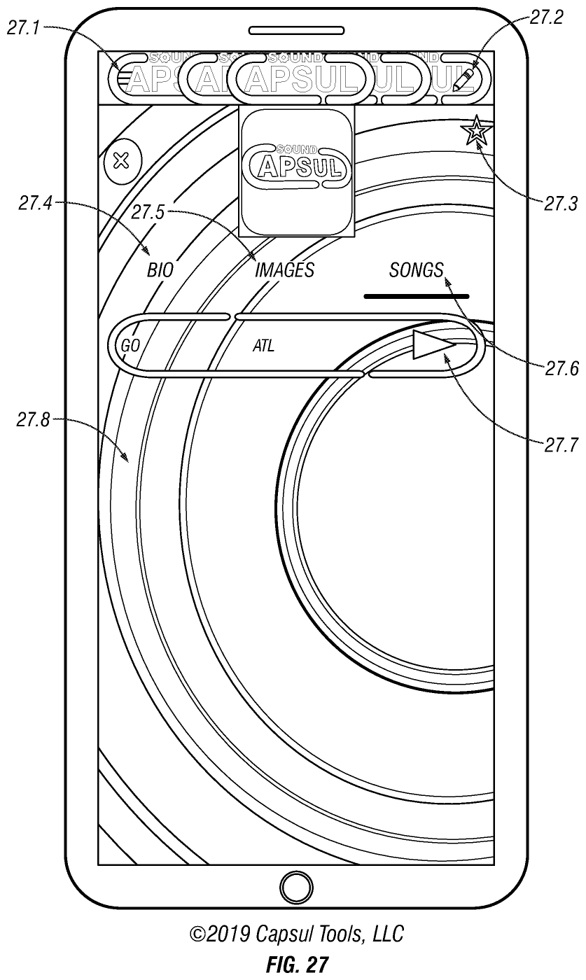

FIG. 27 illustrates a Sound Capsul favorite artist track library page where the user can see the artist's library page. This page includes a Side Menu Button (27.1) to open up the user side menu, a Page Information Edit Button (27.2) visible and active only if the user is viewing the Artist Sound Capsul page of the user currently signed in and allows the user to edit the information associated with the account and then save the changes. By default, it would allow for changes to the “Sound Capsul Artist Bio” tab. In this view it allows the user to add images to the “Sound Capsul Artist Image Gallery”.

A Favorite Artist Button (27.3) toggles between adding or removing an artist from the user's favorite's list. A Sound Capsul Artist Bio Field (27.4) is displayed providing the artists biographical information and is the default view when a user opens an artist “Sound Capsul” page. A Sound Capsul Artist Image Gallery Button (27.5) is provided and when pressed, this button slides the user into the artist “Image Capsul”. A Sound Capsul Artist Music Library Button (27.6) is presented and when pressed, this button slides the user into the artist “Sound Capsul Music Library” which functions as a repository for the artists music in “Sound Capsul” and designated as available for the public.

An Artist Track Play Button (27.7) when pressed this button allows the user to listen to the selected offering from the artist. The Sound Capsul information Window (27.8) displays the information for whichever “Sound Capsul” field button the user is currently viewing. By default, it displays the information associated with the artist “Bio” tab. In this view it displays the “Sound Capsul Artist Music Library” or “Songs” tab.

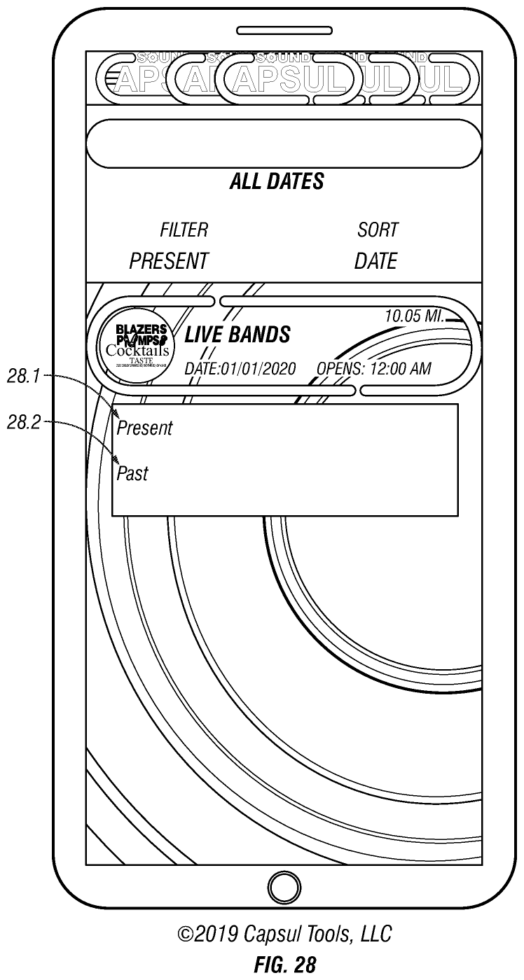

FIG. 28 is a Sound Capsul event filter by date page where a user can view all the events. It consists of a Current Event Filter Button (28.1) that when pressed, allows the user to view all the of events currently available in the “Sound Capsul” network. A Past Event Filter Button (28.2) is provided and when pressed, this button allows the user a view of the historical backlog of prior events available in the “Sound Capsul” network.

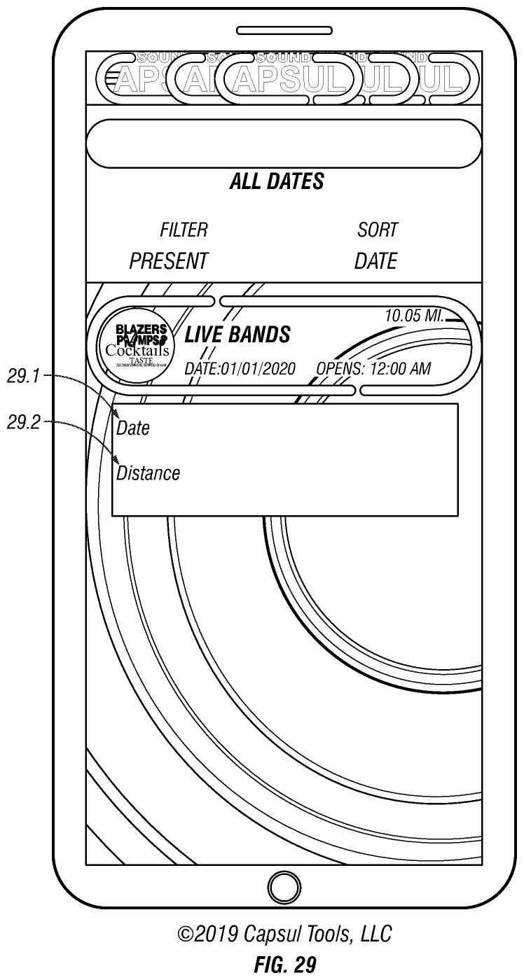

FIG. 29 is a Sound Capsul event sort by date and distance where the user can sort events based on their date. This page includes an Event Sort by Date Button (29.1) that when pressed, allows the user to sort events based on their date. An Event Sort By Distance Button (29.2) is also provided and when pressed, allows the user to view events based on their proximity to the user's location.

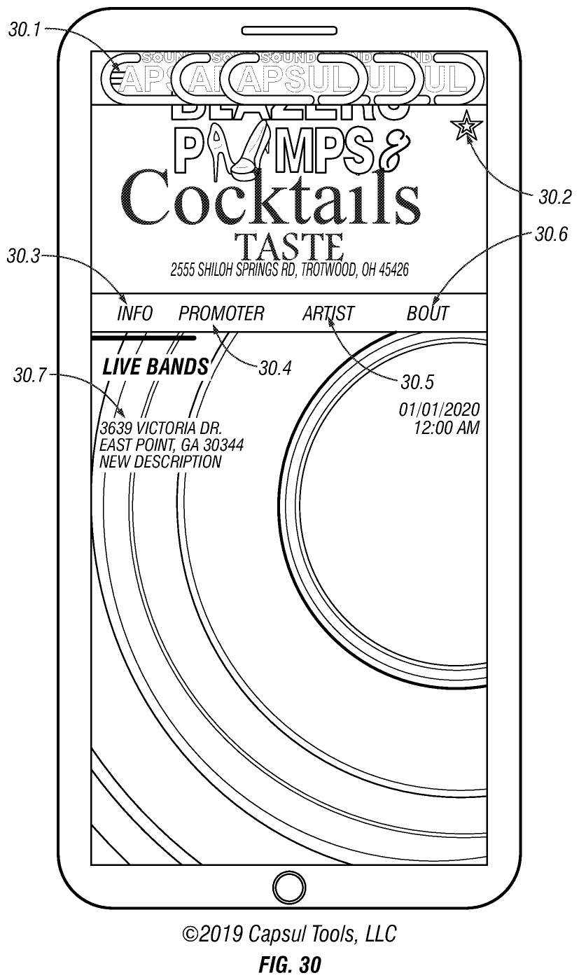

FIG. 30 is a Sound Capsul event page where a user can check the favored and un-favored events list. This events page includes a Side Menu Button (30.1) that opens up the user side menu, a Favor Event Toggle Button (30.2) that when pressed, toggles an event between the status of favored and unfavored in the users “Favorite Events” list accessible in their side menu. A Sound Capsul Event Info Page Button (30.3) is presented and when pressed, this button displays the data recorded in the “Event Info button” displaying it in the “Sound Capsul Information Window” (30.7). This Data will be visible in the “Sound Capsul information Window”.

A Sound Capsul Promoter Information Button (30.4) is provided and when pressed, this button takes the user to the “Sound Capsul Page” associated with the promoter for the selected event. This Data will be visible in the “Sound Capsul information Window” (28.7). A Sound Capsul Event Artist List Page Button (30.5) is also provided and when pressed, this button takes the user to a view which provides the user with a list of the artists associated with the particular event. This Data will be visible in the “Sound Capsul information Window”. An Event Bout Status Data Page Button (30.6) is also provided and when pressed, this button takes the user to a page where the user can view the user's “Bout” rating on the artist's music associated with that particular event. This Data will be visible in the “Sound Capsul information Window”. A Sound Capsul Information Window (30.7) displays the information associated from the tab the user has selected. In its default view it shows the information for the “Info” tab consisting of information about the event (as shown).

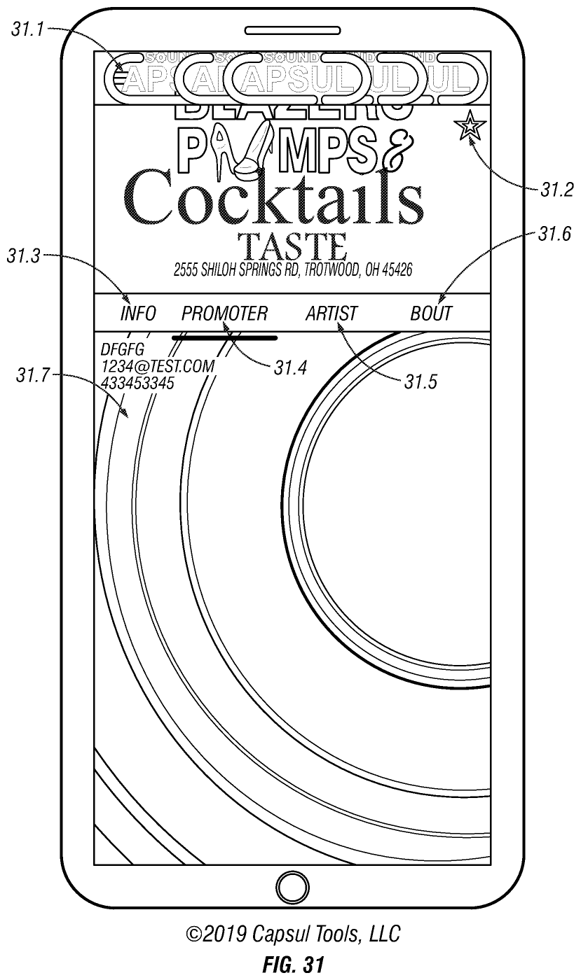

FIG. 31 is a Sound Capsul event promoter page where the promoter can see the selected event. This promoter page includes a Side Menu Button (31.1) to open up the user side menu, a Favored Event Toggle Button (31.2) that when pressed, toggles an event between the status of favored and unfavored in the users “Favorite Events” list accessible in the user's side menu. A Sound Capsul Event Info Page Button (31.3) is provided and when pressed, this button displays the data recorded in the “Event Info button” displaying it in the “Sound Capsul Information Window” (31.7). This Data will be visible in the “Sound Capsul information Window”.

A Sound Capsul Promoter Information Button (31.4) is provided and when pressed, this button takes the user to the “Sound Capsul Page” associated with the promoter for the selected event. This Data will be visible in the “Sound Capsul information Window”. A Sound Capsul Event Artist List Page Button (31.5) is provided and when pressed, this button takes the user to a view which provides the user with a list of the artists associated with the particular event. This Data will be visible in the “Sound Capsul information Window”. An Event Bout Status Data Page Button (31.6) is provided and when pressed, this button takes the user to a page where the user can view the user's “Bout” rating on the artist music associated with that particular event. This Data will be visible in the “Sound Capsul information Window”. A Sound Capsul Information Window (31.7) displays the information associated from the tab the user has selected. In its default view it shows the information for the “Info” tab consisting of information about the event. In this view it provides the user with information associated with the Promoter or Organizer for the event.

FIG. 32 is a Sound Capsul event artist list where users can find the events list for a particular artist. This artist event list includes a Side Menu Button (32.1) to open up the user side menu, a Favor Event Toggle Button (32.2) that when pressed, toggles an event between the status of favored and unfavored in the users “Favorite Events” list accessible in their side menu. A Sound Capsul Event Info Page Button (32.3) when pressed this button displays the data recorded in the “Event Info button” displaying it in the “Sound Capsul Information Window”. This Data will be visible in the “Sound Capsul information Window”.

A Sound Capsul Promoter Information Button (32.4) is also provided and when pressed, this button takes the user to the “Sound Capsul Page” associated with the promoter for the selected event. This Data will be visible in the “Sound Capsul information Window”. A Sound Capsul Event Artist List Page Button (32.5) is also provided and when pressed, as shown here, this button takes the user to a view which provides the user with a list of the artists associated with the particular event. This Data will be visible in the “Sound Capsul information Window” (32.7). An Event Bout Status Data Page Button (32.6) is also provided an when pressed this button takes the user to a page where the user can view the user's “Bout” rating on an artist's music associated with that particular event. This Data will be visible in the “Sound Capsul information Window” (32.7). A Sound Capsul Information Window (32.7) displays the information associated from the tab the user has selected. In its default view it shows the information for the “Info” tab consisting of information about the event. In this view it displays a list of artists associated with the event along with the music they are scheduled to perform.

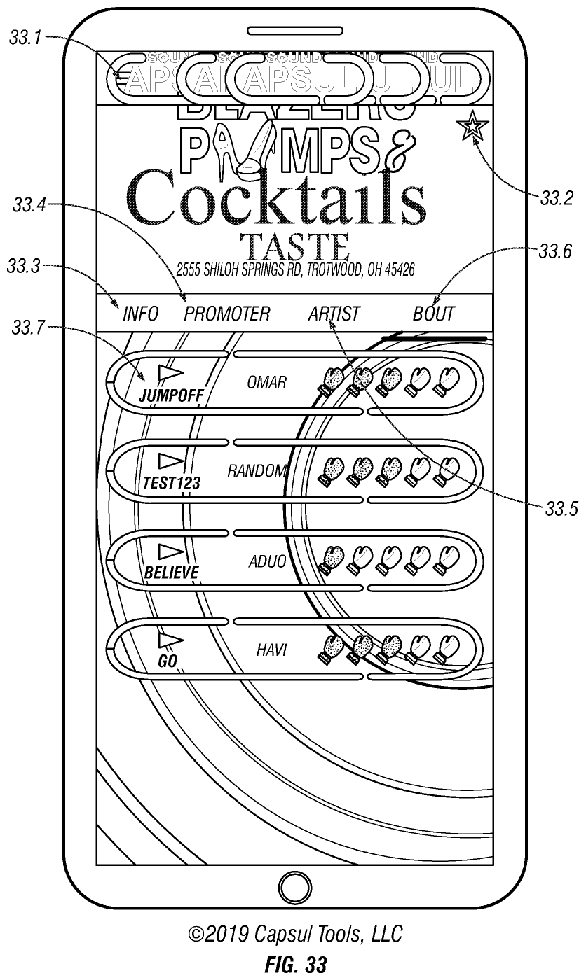

FIG. 33 is a Sound Capsul Event bout rating page where a user can provide a rating to the event associated with the artist. For example, as shown here, the user is provided with the opportunity to rate the artist on a scale ranging from 1 to 5 boxing gloves, or “Bouts”, with five being the highest rating. This event page involves a plurality of fields such as a Side Menu Button (33.1) to open up the user side menu, a Favor Event Toggle Button (33.2) that when pressed, toggles an event between the status of favored and un-favored in the users “Favorite Events” list accessible in the side menu. A Sound Capsul Event Info Page Button (33.3) is provided and when pressed, this button displays the data recorded in the “Event Info button” displaying it in the “Sound Capsul Information Window”. This Data will be visible in the “Sound Capsul information Window” (33.7).

A Sound Capsul Promoter Information Button (33.4) is provided and when pressed, this button takes the user to the “Sound Capsul Page” associated with the promoter for the selected event. This Data will be visible in the “Sound Capsul information Window”. A Sound Capsul Event Artist List Page Button (33.5) is also provided and when pressed this button takes the user to a view which provides the user with a list of the artists associated with the particular event. This Data will be visible in the “Sound Capsul information Window” (33.7). An Event Bout Status Data Page Button (33.6), when pressed, takes the user to a page where the user can view the user's “Bout” rating on an artist's music associated with that particular event. This Data will be visible in the “Sound Capsul information Window”. A Sound Capsul Information Window (33.7) displays the information associated from the tab the user has selected. In its default view it shows the information for the “Info” tab consisting of information about the event. In this view it displays a list of artists associated with the event along with the user's “Bout” ratings for one or more of the entries.

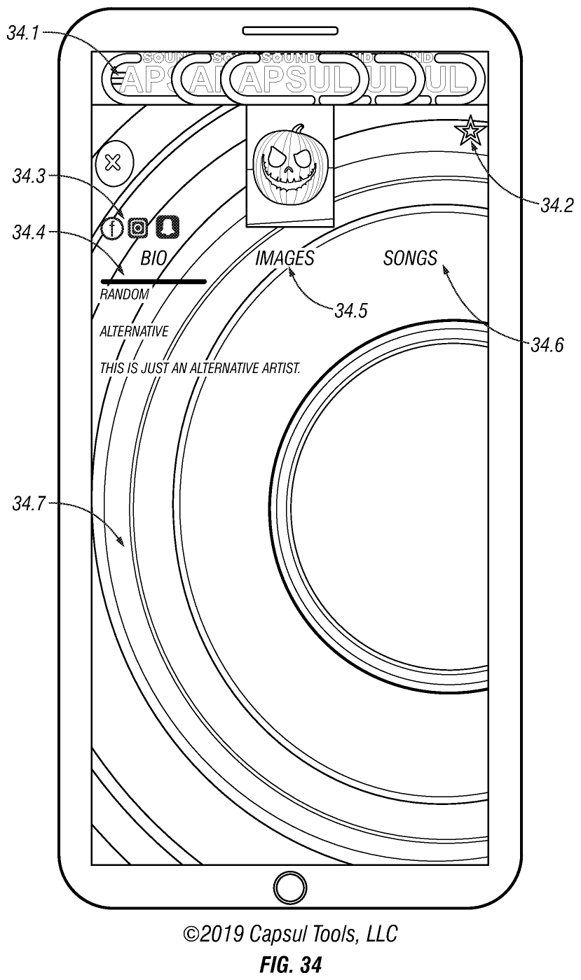

FIG. 34 shows an example Sound Capsul artist page where an artist is provided with access to utilize the page to update the bio-data details for the artist. This page includes a Side Menu Button (34.1) to open up the user side menu, a Favor Artist Toggle Button (34.2) that when pressed, toggles an event between the status of favored and un-favored in the user's “Favored Artist” list accessible in the user's side menu being currently viewed. Social Medial Link Buttons (34.3) are provided to allow the user to connect the user's various social media outlets to the user's “Artist Sound Capsul” account.

A Sound Capsul Artist Bio Screen Button (34.4) is provided and when pressed, this button takes the user to the artist bio window where the artist can edit the information associated with the artist's “Artist Sound Capsul Bio”. This is the default information displayed in the “Artist Sound Capsul Information Window” (34.7). A Sound Capsul Artist Image Gallery Screen Button (34.5) is provided and when pressed, this button takes the user to a page where the user can add images to the user's “Sound Capsul” account. A Sound Capsul Artist Music Edit Page Button (34.6) is also provided and when pressed, this button takes the user to a page where the user has the ability to add music to the user's “Artist Sound Capsul Profile”. A Sound Capsul Information Window (34.7) will display whichever artist Sound Capsul profile button the user has pressed. By default, it displays the “Artist Sound Capsul Bio” information as shown here.

FIG. 35 is an example Sound Capsul artist image gallery page where the artist can add images in the artist's account. This artist gallery page includes fields such as a Side Menu Button (35.1) to open up the user side menu. A Favorite Artist Toggle Button (35.2) is provided and when pressed, toggles an event between the status of favored and un-favored in the users “Favored Artist” list accessible in the user's side menu being currently viewed. A Sound Capsul Artist Bio Screen Button (35.3) is provided and when pressed, this button takes the user to the artist bio window where the user can edit the information associated with the “Artist Sound Capsul Bio”. This is the default information displayed in the “Artist Sound Capsul Information Window” (35.7).

A Sound Capsul Artist Image Gallery Screen Button (35.4) is provided and when pressed, this button takes the user to a page where the user can add images (as shown here) to the user's “Sound Capsul” account. A Sound Capsul Artist Music Edit Page Button (35.5) is also provided and when pressed, this button takes the user to a page where the user has the ability to add music to the user's “Artist Sound Capsul Profile”. An Artist Image Button (35.6) is provided and each of the images in the artist gallery function as its own button, and when pressed, the image buttons offer the user a full screen view of the artist images. A Sound Capsul Information Window (35.7) will display whichever artist Sound Capsul profile button the user has pressed. By default, it displays the “Artist Sound Capsul Bio” information. In this view, the “Images” tab is displayed.

FIG. 36 depict an example Sound Capsul artist library page where the user can select and listen to the selected track by the artist. The page includes a Side Menu Button (36.1) to open up the user side menu, a Favored Artist Toggle Button (36.2) that when pressed, toggles an event between the status of favored and unfavored in the users “Favorite Artist” list accessible in the user's side menu currently being viewed. A Sound Capsul Artist Bio Screen Button (36.3) is provided and when pressed, this button takes the user to the artist bio window where the user can edit the information associated with the user's “Artist Sound Capsul Bio”. This is the default information displayed in the “Artist Sound Capsul Information Window” (36.7). In this view, the “Songs” tab is displayed.

A Sound Capsul Artist Image Gallery Screen Button (36.4) is provided and when pressed, this button takes the user to a page where the user can add images to the user's “Sound Capsul” account. A Sound Capsul Artist Music Edit Page Button (36.5) is provided and when pressed, this button takes the user to a page where the user has the ability to add music to the user's “Artist Sound Capsul Profile”. An Artist Music Play Button (36.6) is provided for each track and when pressed, this button takes the user to a music player link where the user can listen to the selected track by the artist. The Sound Capsul Information Window (36.7) will display whichever artist Sound Capsul profile button the user has pressed. By default, it displays the “Artist Sound Capsul Bio” information. In this view it provides a list of the music the artist has in the Sound Capsul catalog under the “Songs” tab.

FIGS. 37-47 represent exemplary flow charts depicting use of the Sound Capsul app as more fully described below.

FIG. 37 is a flowchart depicting a sign in process involved after installing the Sound Capsul application in the user communication device. After installing the application, the user is displayed with a registration page which starts by displaying a plurality of fields where user need to fill in the details. The page displays a Display Username text field, Password text field, Sign in button, Register button, and Forgot Password button. After entering the required details user clicks on the registration button then the user switches to a registration page where it indicates the registration process is successfully completed.

If the user is an existing account holder then the user can directly sign into the application by clicking on the sign in button and entering the user's user name and password. After entering, the user clicks on the submit button, and if the entered details are correct, the user is allowed to access the application. If the entered user name and/or password are wrong, the app displays a message stating the user name and password is incorrect. The user is then redirected to the username and password entry screen to permit another attempt. As may be desired, the app can provide security to prevent too many incorrect attempts at log in.

If the user while entering user name and password enters the wrong password or forgets the password, the user is provided with a forgot password button. By clicking on the forgot password button, a forgotten password page is displayed. This button takes the user to a forget password page and allows an existing user to request a link enabling the user to change the user's password or to otherwise retrieve a username.

FIG. 38 is a flowchart depicting the registration process involved for accessing the Sound Capsul application after installation. After installing, a user needs to access the application. To access, the user needs to complete the registration process. This process starts by displaying a plurality of fields where the user must to fill in the required personal details such as Username text field, First Name text filed, Last Name text field, Email text field, Password text field, Re-enter Password text field, and zip code text field, and then click on the Register button.

After displaying the fields, the user enters the required registration information and clicks on the submit button where user information is submitted. After submission, if the registration process is complete successfully then the user is allowed to access the Event page or other landing page. If the entered details are wrong, then a message is displayed stating the reason why the registration process is failed.

FIG. 39 is a flowchart depicting a forgot password process, for use if a user after registering the account forgets the password while signing into the application. The password recovery process starts and displays an email text field where the user enters the user's email address or the username associated with the account in order to recover account or reset credentials. After entering, the user submits the email, and if the entered email address is existing in the system, an email with a link that directs the user to a webpage where the user can reset the password and can then sign-in into the sign in page. If the entered email address is wrong, then the system displays a message stating the email address does not exist and redirects the user to re-enter the email address.

FIG. 40 is a flowchart depicting an events search page where a user can search the events associated in the application. For searching an event, the process begins by obtaining the user's current location, and then the app displays to the user the last 30 event details. The displayed listing of the last 30 events comprise a plurality of information such as Display list of events showing event image, title, date, time, and distance from current location; search text field, date picker, past/future filter, and sort appear above the event list. After displaying the fields for searching the required event details, the user enters search address, city or zip code and/or even can change event date, filter or sort type for searching the particular event. By entering the details, the system refreshes the event list based on the parameters on the user screen, then the user selects an event to obtain the required event details.

FIG. 41 is a flowchart depicting the event details associated with an event. This process starts by displaying a page to the user where the user can obtain the event artist, event songs, and event promoter information. To get these details, the user is displayed with an event title, event image, event date/time, event location, event description where the user can browse the required details. After providing the displayed fields, the user can swipe to or tap an event details tab or tap on the provided favorite icon. After browsing the entire required details, the user can add an event to the user's favorite events.

After checking the event details, the user can check the artist event list by clicking the tab display a list of event artists. After checking the artist event list, the user can swipe to or tap an artist tab or tap on the provided icon. After reviewing a list of artist events, the user can select the artist and can get the details of the selected artist.

If the user wants to see a listing of the music for the event, the user can click on the display list of event music where the user can find the music listing. After checking the music list, the user can swipe to or tap the songs tab on the provided icon. After clicking a list of music, the user can select a song and can click play and listen to the interested song. After listening to the song, the user can click on the rating tab where the user can rate the song on a scale from 1 to 5 points to the artist and send the rating which can the be displayed by the artist or in the system to the user.

If the user desires to know details about the event promoter, the user can click on the display tab where the user can find the promoter name, email, phone number and social media links. After checking the promoter info, the user can swipe to or tap promoter tab on the provided icon.

FIG. 42 is a flowchart depicting the artist details associated in the Sound Capsul application. If the user wants to check the artist details of a particular artist in the system, the user can click on the get artist info button. By clicking on it, the page displays the artist name, genre of music performed and bio fields. After checking the artist info, the user can swipe to or tap the artist profile tab on the provided icon.

After checking the artist info, if user desires to add the artist as a favorite artist, the user can click on the tap favorite icon after which, the selected artist gets added to the user's favorite artist list. After checking the artist info, the user can swipe to or tap on the image tab. By clicking on the image tab user can also see the artist images and select the artist by clicking the artist image where user can see the full-size image of the artist. The user can also be provided with the artist list of songs by clicking the display artist songs tab. After checking the list of artist songs, the user can swipe to or tap on the songs tab. By clicking on the songs tab, the user can select the songs from the list and can play the desired song to listen to the song.

FIG. 43 is a flowchart depicting the menu where user can create the artist profile. At the start, the menu page is displayed with a profile image, and if the user taps on the profile image then the user is provided with an option to select a new image from the library or take a new photo. The menu is also displayed with a profile name where the user can edit the user profile screen. The user can also display the artist profile image. The user is provided with a display of an events menu item and by clicking on it, the user can enter into the event search screen where user can browse the events of the selected artist. The menu screen is also displayed with an artist menu item in the artist screen and also provides a favorite menu item where user can select the favorite artist in the favorite screen and finally displays a logout button where by clicking on it, the user can log out of the application.

If the user wishes to create an artist profile, the user can click on the artist profile button which displays artist profile image and artist name where on clicking the profile image tab, the user is given an option to select a new image from the library or take a new photo and for editing the name, the user can click on the edit artist screen tab where the user can change the name. If the artist page is not yet created then the user is shown a page where the user can create an artist screen by entering the artist name.

FIG. 44 is a flowchart depicting the artist screen where the user can get the latest or most current artist details. At the start, if the user wishes to get the artist details, the user needs to select get latest artist info at which time the application displays a list of artists showing a plurality of latest artist's images and names. On the displayed list, if the user wishes to know the details of the artist, then the user needs to click on a particular artist and select the artist. After selecting a particular artist, the user can then view the details of the selected artist.

FIG. 45 is a flowchart depicting the favorite artist, promoter and event functionality of the app. At the start, the user needs to click on the get user favorites tab where the page then displays a list of favorite events, a list of favorite artists and a list of favorite promoters. By clicking on the list of favorite events, the user can see the favored events list and can select a particular event and can get the details of the event. If the user has finished reviewing the selected event, the user can then swipe to another field or can tap the events tab if he/she wants to browse the other events' details.

After shifting to another field, if the user wants to see the favorite artist list, the user needs to click on the display on the favorite artist list, and on this list, the user can select the interested artist and can view the details of the artist. If the user is finished review this particular artist, the user can swipe to other field or can tap the artists tab if he/she wants to browse the other artists' details.

After shifting to the other field, if the user wants to see the favorite promoter list, the user needs to click on the display on the favorite promoters list, and on this list, the user can select a song and can then view the promoter events associated with that song or artist. If user is finished reviewing this particular song or promotor, the user can swipe to another field or can tap the promoter tab if he/she wants to browse the other promoters' details.

FIG. 46 is a flowchart depicting the edit profile screen where a user can edit his/her profile. At the start, the edit profile page is displayed with a plurality of fields such as a Username text field, First Name text field, Last Name text field, Email text field, and zip code text field. If the user needs to edit the profile information, the user can update the data and submit the updated profile information. After submission, if the update is successful the user's profile data is edited and registration of the updated data is indicated to be successful. If the submission is not completed properly, a message stating the reason for registration failure is displayed to the user. Then the user needs to submit the information correctly to complete the registration update process.

FIG. 47 is a flowchart depicting the artist details where a user can see and update the artist information. At the start of the page, if the user needs the artist info, user clicks on the get artist info tab, and it displays the artist name, genre and bio fields. After displaying the data, the user can continue with the profile page or can swipe to the artist profile tab. While displaying the artist details if user wishes to change the artist info, the user needs to click on the change artist info tab.

If the details are updated successfully then the artist updated details are displayed to the user. If not, a message is displayed stating why the update failed. If there is no requirement of changing the artist details, the user can swipe to or tap on an artist profile tab where the user can see the artist image, and if the user wishes to change the artist images, the user selects add image icon where the user is given the option to select a new image from the library or to take a new photo. If the image changing process is completed, the user can swipe to or tap image tab.

On shifting, the user can see the artist songs by clicking on the display artist songs where the user can check a list of songs or can select the add music icon where the user can add the song to the artist play list. The user is also provided with an option to select a new song form the user's device storage. If the user is finished reviewing the songs list, the user can swipe to other field or tap on another songs tab.

In the operation of the app that runs on, e.g., a smartphone, as will be understood in the art, the app interfaces with a web-based or cloud-based database that houses the software for operating the application and houses and updates the collected data. The user's mobile-based app interfaces with the system via web-based or cloud-based interface.

Also disclosed is a method of capturing, storing, retrieving and disseminating personal history information pertaining to the field of musical entertainment for use by a plethora of user types, including: business owners, such as musical performance venue owners or business owners affiliated with a musical performer, promoters promoting the musical artist and events featuring the artist, Disc Jockeys (“DJs”) who are independent or associated with or hired by the musical event venue, the musical artists, the event hosts or event MCs, and general users, such as fans of the artist or attendees of one of the events. This method provides a secure technology-based platform for access by authorized users; provides a mobile and web-based or mobile-app-based graphical user interface, whereby an individual and/or group user(s), via multiple media (video, audio, photographic, text or combinations thereof), can record, store, retrieve and/or disseminate content in an ad hoc or prompted manner regarding musical artists, musical events, promoters, DJs, MCs and hosts for such events, venues for such events and the like as described herein; provides server or cloud-based storage to store such content; and provides multiple options to such user(s) for retrieving such content, including, direct download.

In another embodiment, there is also disclosed is a system for capturing, storing, retrieving and disseminating personal history information pertaining to the field of musical entertainment as noted above. This system comprises: a secure technology-based platform for access by authorized users; a mobile and web-based or mobile-app-based graphical user interface, whereby an individual and/or group user(s), via multiple media (video, audio, photographic, text or combinations thereof), can record, store, retrieve, update and/or disseminate content in an ad hoc or prompted manner regarding musical artists, musical events, promoters, DJs, MCs and hosts for such events, venues for such events and the like as described herein; and a server or cloud-based storage to store such content; interfaces to provide multiple options to such user(s) for retrieving such content, including, direct download.

Also there is disclosed is a computer implemented method of capturing, storing, retrieving and disseminating personal history information pertaining to the field of musical entertainment (regarding musical artists, musical events, promoters for such events, venues for such events, etc., and the like as described herein) comprising the steps of: providing a secure computer technology-based software platform for access by one or more authorized users over a computer network using one or more multimedia computer devices, the one or more computer devices capable of recording content in audio, video, photographic, and/or text format and/or combinations thereof; providing a graphical user interface for use by the one or more users with the one or more multimedia computer devices for interfacing with the platform over the network; interfacing the one or more computer devices with the platform; providing the ability within the platform for the one or more users to record new multimedia content from the one or more computer devices; providing the ability within the platform for the one or more users to access previously existing multimedia content available to the one or more computer devices; providing the ability for the one or more users to review the new or previously existing content from the one or more computer devices from within the platform; providing the ability for the one or more users to edit the new or previously existing content from the one or more computer devices from within the platform; providing the ability for the one or more users to delete the new or previously existing content from the one or more computer devices; providing a platform server or platform cloud-based storage system for use by the one or more users for storing the recorded content within the platform; storing the recorded content onto the platform server or platform cloud-based storage; and providing the one or more users with the ability to retrieve the stored content from the platform server or platform cloud-based storage.

Additionally, there is disclosed is a computer multimedia system for capturing, storing, retrieving and disseminating personal history information pertaining to the field of musical entertainment (regarding musical artists, musical events, promoters for such events, venues for such events, etc. and the like as described herein) comprising: a processor and memory; a secure computer technology-based software platform embodied on one or more computer-readable medium for access by authorized users over a computer network using one or more multimedia computer devices, the one or more computer devices capable of recording content in audio, video, photographic, and/or text format and/or combinations thereof; a graphical user interface embodied on one or more computer-readable medium for the one or more users with the one or more multimedia computer devices for interfacing with the platform over the network; an interface embodied on the one or more computer-readable medium for the one or more users to record new multimedia content from the one or more computer devices; an interface embodied on the one or more computer-readable medium for the one or more users to access previously existing multimedia content available to the one or more computer devices; an interface embodied on the one or more computer-readable medium for the one or more users to review the new or previously existing content from the one or more computer devices from within the platform; an interface embodied on the one or more computer-readable medium for the one or more users to edit the new or previously existing content from the one or more computer devices from within the platform; an interface embodied on the one or more computer-readable medium for the one or more users to delete the new or previously existing content from the one or more computer devices; a platform server or platform cloud-based storage system embodied on one or more computer-readable medium for use by the one or more users for storing the recorded content within the platform; an interface embodied on the one or more computer-readable medium providing the one or more users with the ability to retrieve the stored content from the platform server or platform cloud-based storage. The system may further comprise an artificial intelligence engine embodied on the one or more computer-readable medium for analyzing the specific user content within the platform.

In yet another embodiment there is disclosed a computer program product embodied on one or more non-transitory computer-readable media, said computer program product adapted to be executed to implement a method of capturing, storing, retrieving and disseminating personal history information pertaining to the field of musical entertainment (regarding musical artists, musical events, promoters for such events, venues for such events, etc. and the like as described herein), said method comprising providing a computer-implemented system, wherein the computer implemented system comprises distinct software modules on the one or more computer-readable medium, and wherein the distinct software modules comprise (as provided through the graphic user interface):
a Register module for providing a new user with the ability to register as a registered user of the app in the system;
a Sign-In or Log-In module for accessing a secure computer technology-based software platform by one or more authorized users over a computer network using one or more multimedia computer devices, the one or more computer devices capable of recording content in audio, video, photographic, and/or text format and/or combinations thereof;
a Forgot Password module to permit a registered user to retrieve a forgotten password or change a password;
a User Profile module (and related Edit Profile Module) to permit a registered user to create, view and update/edit/modify such profile with information specific to that user, wherein the registered user could be any one of business owners, such as musical performance venue owners or business owners affiliated with a musical performer, promoters promoting the musical artist and events featuring the artist, Disc Jockeys (“DJs”) who are independent or associated with or hired by the musical event venue, the musical artists, the event hosts or event MCs, and general users, such as fans of the artist or attendees of one of the events.
an Artist Profile/Artist Details module for use by a performing artist to create, view and modify/update/edit an Artist Profile to provide searchable and viewable content (Artist Details) to authorized users of the app with information specific to that artist, such as, for example, Artist Biographical details; Artist uploaded images; Artist Musical Library information, including Artist musical recordings available for authorized users to listen to via the app; information regarding past or upcoming Events featuring the Artist; and links to the Artist's social media;
an Artist Search Module to permit any authorized user to search for and review any Artist Profile stored in the app and to be directed to the Artist Details page for such registered Artist;
an Events Details Module to permit an authorized user to create an Event featuring one or more selected performing artists that are associated with the app. In this module, the authorized user, such as an event venue owner or an event promoter, etc., can create a new Event by inputting all of the relevant details about such Event. Event details include, e.g., date, time and location of the Event, the performing artists featured at the Event, a description of the Event, the Promoter(s) of the event, the list of songs to be performed by a featured Artist at such event, including, for example, the list of songs to be performed and the approximate time those songs will be performed. The Events Details Module will also provide links to the Artist Profiles in the app of those artists performing at the event. Any authorized user may access the Events Details page and can then review the various event details, including adding such event to the User's Favorites Events listing using a Favorites Module;
an Events Search module that permits an authorized user of the app to search for upcoming or prior events. This Events Search module also provides the user with the ability to search for Events based on filter parameters, such as, events that are close in proximity to the User's current location (as determined by, e.g., smartphone GPS technology or the like), events that occur on certain dates, etc. The Events Search module then permits the registered User to search for Events, and then to click on an Event returned in such search to be directed to the Event Details page for such Event. As noted, the Events Details page will also contain links to the Artist Details, etc. for that Event;
a Music Rating Module that provides authorized users to listen to and then review a registered Artist's Music. This module provides the authorized users to rate the music on a scale of 1 to 5 Boxing Gloves, or “BOUTS” to reflect the user's “BOUT Rating” for that particular song. As each registered user rates a registered Artist's particular song, the Music Rating Module calculates an average BOUT Rating across all registered users for that Artist's particular song. In one embodiment, the overall BOUT Rating is displayed under that particular song in the Artist Details section. In another embodiment, the particular user's individual BOUT Rating for that song is displayed to that user along with the overall BOUT Rating when the user is on the Artist Detail page for such song. In another embodiment, the registered user's (or collective users') BOUT Rating(s) for a song performed at an Event is (are) also displayed in connection with the Event Details page listing for such performed song. In yet another embodiment, the BOUT Rating system can be used to provide an overall BOUT Rating for an Event;
a Favorites Module that permits an authorized user to designate selected Artists, Artists Music, Events, and Event Promoters as being “Favorites” of that particular user. The Favorites Module also provides the registered user with the ability to review a listing of such designated Favorites, such as a Favorite Artist (and then be provided with a link to the Artist Details page for that Artist), a Favorite Event (and then be provided with a link to the Event Details page for that Artist), or a Favorite Promoter (and then be provided with a link to the Promoter Details page for that Promoter); and
a Menu Module providing the registered user with a way to navigate between the various modules listed above, or to log out of the system.

In these various embodiments, the multimedia computer devices may be selected from the group consisting of smartphones, tablets, personal computers, and laptops and the like. The graphical user interface is mobile-based and web-based or mobile-app-based.

Web Portal. In additional to the ability to access the app via a smartphone or other multimedia computer device, where the app is downloaded to the device and interfaces with data via network connections, there is also provided a web portal for accessing the app.

Referring now to Figures, 48-58 (along with and in view of the teachings set out herein regarding FIGS. 1-47), there are shown exemplary screen shots from a web portal that can be used for accessing the app via a web interface rather than via a smart phone app, such as described above in connection with FIGS. 1-47. The web portal provides the same functionality as with the mobile app, and the following screen shots are just illustrative of the functionality of the web portal.

FIG. 48 is an exemplary screen shot from a web portal landing page for the log-in into the application using the user's log-in credentials (e.g., username (48.1) and password (48.2)). On this screen, there is provided a Sound Capsul Username Field (48.1) where the user would insert the username associated with the user's “Sound Capsul” profile. The Sound Capsul Password Field (48.2) is the field where the user would insert the password associated with the user's “Sound Capsul” profile. Fields 48.1 and 48.2 are prerequisite fields to be populated with verifiable data before the user can enter the portal via the Log-in Button (48.3). The Sound Capsul Log-In Button (48.3) is only active when the user has entered the authorized prerequisite data into the Username and Password fields 48.1 and 48.2. Once the user's credentials have been validated, the user is provided with entrance to the portal. If the user has not yet registered, the user will be directed to a registration screen (FIG. 49) after clicking on the Register Button (48.4).

FIG. 49 is an exemplary screen shot from a web portal registration screen for the application providing the new user with a plurality of data fields to complete, including: a Sound Capsul Portal Username Selection Field (49.1) where the user would insert the username to be associated with the user's “Sound Capsul Profile”; a Sound Capsul Portal User First Name Field (49.2) where the user would insert the user's first name; a Sound Capsul Portal User Last Name Field (49.3) where the user would insert the user's last Name; a Sound Capsul Portal User Phone Number Field (49.4) where the user would insert the user's phone number; a Sound Capsul Portal User Zip Code Field (49.5) where the user would insert the zip code associated with, e.g., the user's primary residence; a Sound Capsul Portal User Sexual Identification Selection List (49.6) where the user is provided with options to select; a Sound Capsul Portal User Email Field (49.7) where the user would insert the email address the users wants associated with the user's “Sound Capsul” profile, such email required to be unique and not already in use within the Sound Capsul database; a Sound Capsul Portal Password Field (49.8) where the user will insert the unique password the user intends to be associated with the user's “Sound Capsul” profile; and a Sound Capsul Portal Password Confirmation Field (49.9) where the user confirms the chosen password by re-entering it, the user being provided with a visual confirmation as to whether or not the keyed-in passwords are identical. The above data fields are preferably all prerequisites for registration into the portal. The registration screen also provides Sound Capsul Portal Business Profile Page Creation Link List buttons (49.10) to select if the user is also an Artist or Promoter and after selection of one of such buttons, the user will be directed to registration pages for creating auxiliary accounts based on a predetermined list of services as described further herein. Once the registration process is completed, the user can then press the Sound Capsul Portal Register Button (49.11), a button that will only become active when the user has filled out the prerequisite fields indicated above, and when pressed, it completes the user's registration into the app.

FIG. 50 is an exemplary screen shot from a web portal promoter registration screen for the application displaying a plurality of data fields to be completed by the promoter seeking registration, including: a Promoter Name/Organization Field (50.1) where the user would insert the name of the individual or organization the user is creating as a “Sound Capsul Promoter Profile”; a Promoter Phone Number Field (50.2) where the user would insert the phone number to be associated with this “Sound Capsul Promoter Profile”; a Portal Promoter Email Address Field (50.3) where the user would place the email address to be associated with this “Sound Capsul Promoter Profile”; Promoter Zip Field (50.4) where the user would input the zip code of the city of the Promoters primary place of business; a Promoter Facebook Address Field (50.5) where the user inputs the Facebook address to be associated with this “Sound Capsul Promoter Profile”; a Promoter Instagram Name Field (50.6) where the user would insert the Instagram name to be associated with this “Sound Capsul Promoter Profile”; and a Promoter Snapchat Field (50.7) where the user would insert the Snapchat identity to be associated with this “Sound Capsul Promoter Profile”. Once completed, a Sound Capsul Portal Promoter Registration Button (50.8) becomes active when the requisite fields (e.g., 50.1-50.4) are completed. When pressed, it registers the user also as a promoter in the “Sound Capsul Portal”.

FIG. 51 is an exemplary screen shot from a web portal event home screen for the application. A Sound Capsul Portal Event Icon (51.1) is provided and when pressed, this button takes the user to this displayed “Sound Capsul Event Portal Home” screen. Also displayed on this screen is a Sound Capsul Portal Artist Icon (51.2) and when pressed, this button takes the user to the “Sound Capsul Artist Portal Page” such as described below in connection with, e.g., FIG. 53. This screen also displays a Sound Capsul Portal User Profile Icon (51.3) that when pressed, this button takes the user to the applicable “Sound Capsul User Portal List Page”. A Sound Capsul Portal Logout Icon (51.4) is also displayed and when pressed, this button logs out the user and takes the user back to the to the “Sound Capsul Portal Landing Page” (FIG. 48). On this events page there is also provided a Sound Capsul Portal Event Calendar (51.5), a Sound Capsul Portal Add Event Button (51.6) and a Sound Capsul Portal Promoter Active Event Window (51.7). If there is an active event on a date selected from the calendar (51.5), the event will be displayed in the active event section (51.7) of the screen. Clicking on the displayed event will take the user to the Event Details screen for such event. New events can be added by clicking on the Add Event button (51.6), e.g., by a registered Promoter adding events that the Promoter is promoting.

For example, FIG. 52 presents an exemplary screen shot from a web portal promoter event add screen for the application to associate a new event with a user's profile. Again, displayed at the top of the screen are the Sound Capsul Portal Event Icon (52.1) which, when pressed, takes the user to the “Sound Capsul Event Portal Home”. Again, displayed at the top of this screen is the Sound Capsul Portal Artist Icon (52.2) which when pressed, takes the user to a page where the user can access the artist's music within the system as well as add new artists and new music. Again, a Sound Capsul Portal User Profile Icon (52.3) is displayed and when pressed, this button takes the user to the “Sound Capsul Artist Portal List Page”. Again, displayed is a Sound Capsul Logout Icon (53.4) which when pressed, this button logs out the user and takes the user to the “Sound Capsul Portal Landing Page”. When adding a new event, the Promoter enters data into the displayed fields, such as: Sound Capsul Event Name Field (52.5) where the user would enter the name of the event the user is adding to the app; the Sound Capsul Event Type List (52.6); the Sound Capsul Event Location Field (52.7), Event Street Address Field (52.8), Event City Field (52.9), Event State Field (52.10) and Event Zip (zip code) Field (52.11) to identify location details for the where the event will be held. A Sound Capsul Portal Event Promoter List Field (52.12) is provided for the user to input the name of the promoter for the event. Time Field (52.13) and Date Field (52.14) is provided for the user to supply the time and date details for the event. A YouTube (or similar) Video Link Field (52.15) can be provided to link to video content relevant to, or promoting, the event. An Event Description Field (52.16) is provided to set forth a description of the event. An Event Marketing Material Link (browse) button (52.17) is provided to link the user to relevant content about the event. When the Event details have been added, the user then clicks on the Event Submission Button (52.18).

FIG. 53 is an exemplary screen shot from a web portal artist list screen for the application. Again, displayed at the top of the screen are the Sound Capsul Portal Event Icon (53.1) which, when pressed, takes the user to the “Sound Capsul Event Portal Home”. Again, displayed at the top of this screen is the Sound Capsul Portal Artist Icon (53.2) which when pressed, takes the user to a page where the user can access the artist's music within the system as well as add new artists and new music. Again, a Sound Capsul Portal User Profile Icon (53.3) is displayed and when pressed, this button takes the user to the “Sound Capsul Artist Portal List Page”. Again, displayed is a Sound Capsul Logout Icon (53.4) which when pressed, this button logs out the user and takes the user to the “Sound Capsul Portal Landing Page”. A Sound Capsul Portal Artist Search Window (53.5) is provided that permits the user to search for Artists that are registered in the “Sound Capsul Database”. A Sound Capsul Portal Add Artist Button (53.6) is provided and when pressed, this button directs the user (e.g., Promoter, Artist) to a screen where the user can add a new artist and new artist content to the event. A Sound Capsul Portal Artist Capsul (53.7) link is displayed for any artist that has been added to an event, and when pressed, this button takes the user to a screen where the user can manipulate the content of that particular artist's “Capsul” as may be desired. Also displayed is a scrollable Sound Capsul Portal Active Artist List (53.8).

FIG. 54 depicts an exemplary screen shot from a web portal promoter event edit add artist screen for the application. Again, displayed at the top of the screen are the Sound Capsul Portal Event Icon (54.1) which, when pressed, takes the user to the “Sound Capsul Event Portal Home”. Again, displayed at the top of this screen is the Sound Capsul Portal Artist Icon (54.2) which when pressed, takes the user to a page where the user can access the artist's music within the system as well as add new artists and new music. Again, a Sound Capsul Portal User Profile Icon (54.3) is displayed and when pressed, this button takes the user to the “Sound Capsul Artist Portal List Page”. Again, displayed is a Sound Capsul Logout Icon (54.4) which when pressed, this button logs out the user and takes the user to the “Sound Capsul Portal Landing Page”. A Sound Capsul Portal Event Details Edit Button (54.5) is displayed and when pressed, directs the user to a page where the user can edit the detail associated with the event. Shown here is an example of marketing materials uploaded and displayed regarding a particular Hip-Hop event. If an artist has already been associated with this event within the Sound Capsul system, a Sound Capsul Portal Artist Capsul (54.6) will appear in the Events Artists section (54.8) of the screen, and when pressed, this Artist Capsul button takes the user to a screen where the user can manipulate the content of that particular artist's “Capsul” content for the event. If desired, a Sound Capsul Portal Add Artist Button (54.7) can be pressed to take the user to a screen where the user can add a new artist and new artist content to the event.

FIG. 55 is an exemplary screen shot from a web portal promoter profile edit screen for the application. Again, displayed at the top of the screen are the Sound Capsul Portal Event Icon (55.1) which, when pressed, takes the user to the “Sound Capsul Event Portal Home”. Again, displayed at the top of this screen is the Sound Capsul Portal Artist Icon (55.2) which when pressed, takes the user to a page where the user can access the artist's music within the system as well as add new artists and new music. Again, a Sound Capsul Portal User Profile Icon (55.3) is displayed and when pressed, this button takes the user to the “Sound Capsul Artist Portal List Page”. Again, displayed is a Sound Capsul Logout Icon (55.4) which when pressed, this button logs out the user and takes the user to the “Sound Capsul Portal Landing Page”. A Sound Capsul Promoter Profile Image Edit Field button (55.5) is provided and when pressed this opens a field where the user can edit the image associated with the user's (promoter's) Sound Capsul promoter profile, such as a photo or logo icon. The user can enter data into or otherwise edit existing data in a variety of fields, such as: Sound Capsul Promoter Profile Name Edit Field (55.6) to provide the name of the Promoter; Sound Capsul Promoter Profile Zip Code Edit Field (55.7) for input of the Promoter's sip code; Sound Capsul Promoter Profile Phone Number Edit Field (55.8) for entry of the Promoter's desired phone number; Sound Capsul Promoter Profile Email Edit Field (55.9) for entry of the Promoter's desired email address; Sound Capsul Promoter Profile Social media Name Edit Fields for entry of the Promoter's desired social media identities, e.g., Snapchat User Name Edit Field (55.10), Instagram User Name Edit Field (55.11) and Facebook Profile Name Edit Field (55.12). Once the Promoter Profile input/editing is complete, the user clicks on the Sound Capsul Promoter Profile Update Button (55.13) which when pressed, updates the user's “Sound Capsul Promoter Profile” to reflect the information the user just entered.

FIG. 56 is an exemplary screen shot from a web portal artist profile screen for the application. Displayed at the top of the screen is a “Sound Capsul Portal Artist Profile Button” (56.1), which when pressed, directs the user to the “Sound Capsul Portal Artist Profile Page” where the user can edit the information associated with the user's “Sound Capsul Artist Profile”. Also displayed at the top of this screen is the “Sound Capsul Portal Artist Image Gallery Button” (56.2) which when pressed, this button takes the user to the “Sound Capsul Portal Artist Image Gallery”, where the user could add or remove images from the user's profile. Also, displayed at the top of the screen is a “Sound Capsul Portal Artist Music Library Button” or “Songs Button” (56.3) which when pressed takes the user to the user's “Sound Capsul Portal Music Library” where the user can add or remove music from the user's (Artist's) catalog contained in the app system. Again, displayed is a “Sound Capsul Logout Icon” (56.4) which when pressed, this button logs out the user and takes the user to the “Sound Capsul Portal Landing Page”. A Sound Capsul Portal Artist Upload Image Button (56.5) is provided and when pressed, this button directs the user to a link which allows the user to upload a profile picture for the user's (Artist's) “Sound Capsul Artist Profile” and a Sound Capsul Portal Submit Button (56.6) is provided and when pressed, submits the changes the user has made to the user's “Sound Capsul Artist Profile”. The Artist can edit the Sound Capsul Portal Artist Name Edit Field (56.7) to change the artist name, the Sound Capsul Portal Artist Bio Field (56.8) to change the Artist's bio, and the Sound Capsul Portal Artist Genre List (56.9) to change the music genre associated with the Artist's “Sound Capsul Artist Profile”. A Sound Capsul Portal Artist Update Button is provided, and when pressed, this button updates the changes the user made to the user's “Sound Capsul Artist Profile”.

FIG. 57 depicts an exemplary screen shot from a web portal artist image gallery screen for the application. Again, displayed at the top of the screen is a “Sound Capsul Portal Artist Profile Button” (57.1), which when pressed, directs the user to the “Sound Capsul Portal Artist Profile Page” where the user can edit the information associated with the user's “Sound Capsul Artist Profile”. Also again displayed at the top of this screen is the “Sound Capsul Portal Artist Image Gallery Button” (57.2) which when pressed, this button takes the user to the “Sound Capsul Portal Artist Image Gallery”, where the user could add or remove images from the user's profile. Also, again displayed at the top of the screen is a “Sound Capsul Portal Artist Music Library Button” or “Songs Button” (57.3) which when pressed takes the user to the user's “Sound Capsul Portal Music Library” where the user can add or remove music from the user's (Artist's) catalog contained in the app system. Again, displayed is a “Sound Capsul Logout Icon” (57.4) which when pressed, this button logs out the user and takes the user to the “Sound Capsul Portal Landing Page”. A Sound Capsul Portal Artist Upload Image Button (57.5) is provided and when pressed, this button takes the user to a link which allows the user to upload a profile picture for the user's “Sound Capsul Artist Profile”. A Sound Capsul Portal Submit Button (57.6) is provided and when pressed, submits the changes the user has made to the user's “Sound Capsul Artist Image Gallery”.

FIG. 58 is an exemplary screen shot from a web portal artist music add screen for the application Again, displayed at the top of the screen is a “Sound Capsul Portal Artist Profile Button” (58.1), which when pressed, directs the user to the “Sound Capsul Portal Artist Profile Page” where the user can edit the information associated with the user's “Sound Capsul Artist Profile”. Also again displayed at the top of this screen is the “Sound Capsul Portal Artist Image Gallery Button” (58.2) which when pressed, this button takes the user to the “Sound Capsul Portal Artist Image Gallery”, where the user could add or remove images from the user's profile. Also, again displayed at the top of the screen is a “Sound Capsul Portal Artist Music Library Button” or “Songs Button” (58.3) which when pressed takes the user to the user's “Sound Capsul Portal Music Library” where the user can add or remove music from the user's (Artist's) catalog contained in the app system. Again, displayed is a “Sound Capsul Logout Icon” (58.4) which when pressed, this button logs out the user and takes the user to the “Sound Capsul Portal Landing Page”. A Sound Capsul Portal Artist Song Title Field (58.5) is provided for the user to insert the title of the song that the user desires to add to the user's “Sound Capsul Artist Profile”. A Sound Capsul Portal Artist Album Field (58.6) is provided for the user to insert the album name associated with the song being uploaded to the user's “Sound Capsul Artist Profile”. A Sound Capsul Portal Upload Song Button (58.7) is provided and when pressed, this button directs the user to a link where the user can upload a song to the user's (e.g., Artist's) “Sound Capsul Artist Profile”. A Sound Capsul Portal Submit Button (58.8) is provided and when pressed, this button submits the changes the user has made to the user's “Sound Capsul Artist Song Listings”.

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

I claim:

1. A system and method to group individuals by providing a music platform to update the music events and coordinating:
obtaining entertainment event data from a plurality of data sources;
acquiring artist data, wherein the artist is associated with the entertainment event;
providing an application that allows a user of the application, via a user interface, to access information associated with the entertainment event;
providing an application that allows a promoter to market the entertainment event; and
creating a database, wherein the database includes information related to users and the associated events.

2. The system according to claim 1, wherein a plurality of individuals are grouped and are associated with the music platform, wherein the plurality of individuals are selected from the group consisting of:
business owners;
promoters;
DJs;
performing artists;
hosts; and
general users.

3. The system according to claim 2, wherein each of the individuals associated with the application creates an account by registering in the application.

4. The system according to claim 1, characterized to include at least one of location, date, time, venues, samples of the artist material, advertisements and related events.

5. The system according to claim 2, wherein the business owners have the ability to create/manage events and can save their favorite promoter, DJ, artist, and host.

6. The system according to claim 2, wherein the promoters have the ability to create events associated with the artists, add artists to events, add DJs and hosts to events, manage event songs order, enable/disable voting, enable/disable event registration, view the promoters' events inside the app, download and play event music, manage the promoters' personal profile and send push notification to event artists, DJs, and hosts.

7. The system according to claim 2, wherein the DJs have the ability to view events, activate and deactivate voting, rearrange song order, turn on or off voting registration, download and play event songs, create/manage DJ profile and manage events scoreboard.

8. The system according to claim 2, wherein the artists have the ability to add unlimited songs to their profiles, upload songs, upload images, edit artists' information, sign up for an event, check into an event, and receive push notification.

9. The system according to claim 2, wherein the hosts have the ability to view events and create/manage hosts' profiles.

10. A method of capturing, storing, retrieving and disseminating personal history information pertaining to the field of musical entertainment for use by one or more authorized users, comprising the steps of:
a. providing a secure technology-based platform for access by the one or more authorized users;
b. providing a mobile and web-based or mobile-app-based graphical user interface, whereby the one or more authorized users and/or one or more groups of the one or more authorized users, can via multiple media record, store, retrieve and/or disseminate content in an ad hoc or prompted manner regarding musical artists, musical events featuring the musical artists, and promoters, DJs, MCs, hosts and venues for such musical events;
c. providing server or cloud-based storage to store such content; and
d. providing multiple options to such one or more authorized users for retrieving such content, including, direct download.

11. The method of claim 10 wherein the one or more authorized users are selected from the group consisting of: business owners, such as owners of the venues for such musical events, business owners affiliated with the musical artist, the promoters promoting the musical artist and musical events featuring the musical artist, DJs who are independent or associated with or hired by the venues for the musical events, the musical artists, the musical event hosts or the musical event MCs, and general users, such as fans of the musical artist or attendees of one of the musical events.

12. The method of claim 10 wherein the multiple media comprises video, audio, photographic, text or combinations thereof.

13. A system for capturing, storing, retrieving and disseminating personal history information pertaining to the field of musical entertainment for use by one or more authorized users, comprising:
a. a secure technology-based platform for access by authorized users;
b. a mobile and web-based or mobile-app-based graphical user interface, whereby the one or more authorized users and/or one or more groups of the one or more authorized users, can via multiple media record, store, retrieve and/or disseminate content in an ad hoc or prompted manner regarding musical artists, musical events featuring the musical artists, and promoters, DJs, MCs, hosts and venues for such musical events;
c. a server or cloud-based storage system to store such content; and
d. interfaces to provide multiple options to such one or more authorized users for retrieving such content, including, direct download.

14. A computer implemented method of capturing, storing, retrieving and disseminating personal history information pertaining to the field of musical entertainment comprising the steps of:
a. providing a secure computer technology-based software platform for access by one or more authorized users over a computer network using one or more multimedia computer devices, the one or more computer devices capable of recording content in audio, video, photographic, and/or text format and/or combinations thereof;
b. providing a graphical user interface for use by the one or more authorized users with the one or more multimedia computer devices for interfacing with the platform over the network;
c. interfacing the one or more computer devices with the platform;
d. providing the ability within the platform for the one or more authorized users to record new multimedia content from the one or more computer devices;
e. providing the ability within the platform for the one or more authorized users to access previously existing multimedia content available to the one or more computer devices;
f. providing the ability for the one or more authorized users to review the new or previously existing content from the one or more computer devices from within the platform;
g. providing the ability for the one or more authorized users to edit the new or previously existing content from the one or more computer devices from within the platform;
h. providing the ability for the one or more authorized users to delete the new or previously existing content from the one or more computer devices;
i. providing a platform server or platform cloud-based storage system for use by the one or more authorized users for storing the recorded content within the platform;
j. storing the recorded content onto the platform server or platform cloud-based storage; and
k. providing the one or more authorized users with the ability to retrieve the stored content from the platform server or platform cloud-based storage.

15. A computer multimedia system for capturing, storing, retrieving and disseminating personal history information pertaining to the field of musical entertainment comprising:
a. a processor and memory;
b. a secure computer technology-based software platform embodied on one or more computer-readable medium for access by authorized users over a computer network using one or more multimedia computer devices, the one or more computer devices capable of recording content in audio, video, photographic, and/or text format and/or combinations thereof;
c. a graphical user interface embodied on one or more computer-readable medium for the one or more authorized users with the one or more multimedia computer devices for interfacing with the platform over the network;
d. an interface embodied on the one or more computer-readable medium for the one or more authorized users to record new multimedia content from the one or more computer devices;
e. an interface embodied on the one or more computer-readable medium for the one or more authorized users to access previously existing multimedia content available to the one or more computer devices;
f. an interface embodied on the one or more computer-readable medium for the one or more authorized users to review the new or previously existing content from the one or more computer devices from within the platform;
g. an interface embodied on the one or more computer-readable medium for the one or more authorized users to edit the new or previously existing content from the one or more computer devices from within the platform;
h. an interface embodied on the one or more computer-readable medium for the one or more authorized users to delete the new or previously existing content from the one or more computer devices;
i. a platform server or platform cloud-based storage system embodied on one or more computer-readable medium for use by the one or more authorized users for storing the recorded content within the platform; and
j. an interface embodied on the one or more computer-readable medium providing the one or more authorized users with the ability to retrieve the stored content from the platform server or platform cloud-based storage.

16. The system of claim 15 further comprising an artificial intelligence engine embodied on the one or more computer-readable medium for analyzing the specific authorized user content within the platform.

17. A computer program product app embodied on one or more non-transitory computer-readable media, said computer program product adapted to be executed to implement a method of capturing, storing, retrieving and disseminating personal history information pertaining to the field of musical entertainment, said method comprising providing a computer-implemented system, wherein the computer implemented system comprises distinct software modules on the one or more computer-readable medium, and wherein the distinct software modules comprise (as provided through a graphic user interface):
a. a Register module for providing a new user with the ability to register as a registered user of the app in the system;
b. a Sign-In or Log-In module for accessing a secure computer technology-based software platform by one or more registered users over a computer network using one or more multimedia computer devices, the one or more computer devices capable of recording content in audio, video, photographic, and/or text format and/or combinations thereof;
c. a Forgot Password module to permit a registered user to retrieve a forgotten password or change a password;
d. a User Profile module (and related Edit Profile Module) to permit a registered user to create, view and update/edit/modify such profile with information specific to that registered user, wherein the registered user could be any one of business owners, such as musical performance venue owners or business owners affiliated with a musical performer, promoters promoting the musical artist and events featuring the artist, Disc Jockeys (“DJs”) who are independent or associated with or hired by the musical event venue, the musical artists, the event hosts or event MCs, and general users, such as fans of the artist or attendees of one of the events;
e. an Artist Profile/Artist Details module for use by a performing artist to create, view and modify/update/edit an Artist Profile to provide searchable and viewable content (Artist Details) to registered users of the app with information specific to that artist, such as, for example, Artist Biographical details; Artist uploaded images; Artist Musical Library information, including Artist musical recordings available for registered users to listen to via the app; information regarding past or upcoming Events featuring the Artist; and links to the Artist's social media;
f. an Artist Search Module to permit any registered user to search for and review any Artist Profile stored in the app and to be directed to the Artist Details page for such registered Artist;
g. an Events Details Module to permit a registered user to create an Event featuring one or more selected performing artists that are associated with the app; wherein the registered user can create a new Event by inputting all of the relevant details about such Event, such as date, time and location of the Event, the performing artists featured at the Event, a description of the Event, the Promoter(s) of the event, the list of songs to be performed by a featured Artist at such event, including, for example, the list of songs to be performed and the approximate time those songs will be performed; wherein the Events Details Module also provides links to the Artist Profiles in the app of those artists performing at the event; and wherein any registered user may access the Events Details page and can then review the various event details, including adding such event to the User's Favorites Events listing using a Favorites Module;
h. an Events Search module that permits a registered user of the app to search for upcoming or prior events. This Events Search module also provides the user with the ability to search for Events based on filter parameters, such as, events that are close in proximity to the User's current location (as determined by, e.g., smartphone GPS technology or the like), events that occur on certain dates, etc. The Events Search module then permits the registered User to search for Events, and then to click on an Event returned in such search to be directed to the Event Details page for such Event. As noted, the Events Details page will also contain links to the Artist Details, etc. for that Event;
i. a Music Rating Module that provides registered users to listen to and then review a registered Artist's Music; wherein this module provides the registered user to rate the music on a scale of 1 to 5 Boxing Gloves, or “BOUTS” to reflect the registered user's “BOUT Rating” for that particular song; wherein as each registered user rates a registered Artist's particular song, the Music Rating Module calculates an average BOUT Rating across all registered users for that Artist's particular song;
j. a Favorites Module that permits a registered user to designate selected Artists, Artists Music, Events, and Event Promoters as being “Favorites” of that particular registered user; and
k. a Menu Module providing the registered user with a way to navigate between the various modules listed above, or to log out of the system.

18. The computer program product app of claim 17 wherein the multimedia computer devices are selected from the group consisting of smartphones, tablets, personal computers, and laptops.

19. The computer program product app of claim 17 wherein the graphical user interface is mobile-based and web-based or mobile-app-based.
